(19) United States
(12) Patent Application Publication
(10) Pub. No.: US 2016/0134934 A1
(43) Pub. Date: May 12, 2016

(54) ESTIMATING AUDIENCE SEGMENT SIZE CHANGES OVER TIME

(71) Applicant: Adobe Systems Incorporated, San Jose, CA (US)

(72) Inventors: David A. Jared, Denver, CO (US); David M. Weinstein, Rockville Centre, NY (US)

(21) Appl. No.: 14/534,744

(22) Filed: Nov. 6, 2014

(51) Int. Cl. H04N 21/442; H04N 21/81

(52) U.S. Cl. CPC H04N 21/44213; H04N 21/812

(57) ABSTRACT

Methods, computer readable storage media, and systems for estimating and predicting audience segment sizes are provided. An exemplary method receives a request for segment sizes for a defined audience segment, the request indicating one or more traits of visitors of network content and a time range. The method then retrieves audience data based at least in part on the one or more traits and the time range. Next, the method calculates, based at least in part on the retrieved audience data, audience segment population sizes for a plurality of durations in the time range.

### TECHNICAL FIELD

This disclosure relates generally to computer-implemented methods and systems for calculating and estimating changes in audience size and more particularly to near real-time estimation of audience segment sizes over time.

### BACKGROUND

Goods and services providers employ various forms of marketing to drive consumer demand for products and services. Marketing includes various techniques to expose to target audiences to brands, products, services, and so forth. For example, marketing often includes providing offers and promotions (e.g., advertisements) to an audience to encourage audience members to purchase a product or service. In some instances, promotions are provided through media outlets, such as television, radio, and the Internet via television commercials, radio commercials and webpage advertisements. In the context of webpages, marketing may include advertisements for a website and products or services associated with that website so as to encourage audience members to visit and/or use the website, purchase products and services offered via the website, and/or to otherwise interact with the website.

In marketing or other applications, data may be managed. User data management is the collection and analysis of user website interaction data. It can include collecting information about how individual audience members (e.g., visitors or consumers) interact with a given website. Prior solutions for calculating the number of web site visitors in a given audience segment typically require an ‘offline’ calculation performed as a scheduled job. As calculating an audience size for segments of consumers or visitors can be extremely computational expensive, prior solutions typically perform such calculations as part of a nightly job. Also, such calculations are limited to only calculating a current, single audience size. These prior solutions do not calculate the number of visitors that are in a given audience segment in near real-time, nor do they calculate changes in audience segment sizes over time. Existing techniques also do not predict or estimate how an audience segment size will change at different points in time in the future.

Therefore, there is a need for techniques for calculating audience segment sizes over time and estimating future changes in audience segment sizes in near real-time.

### SUMMARY

One exemplary embodiment involves receiving, at a computing device, a request for segment sizes for a defined audience segment, the request indicating one or more traits of visitors of network content and a time range. According to this embodiment, audience data is retrieved based at least in part on the one or more traits and the time range. Next, the embodiment calculates, by the computing device, based on the audience data, audience segment population sizes for a plurality of durations in the time range.

These illustrative features are mentioned not to limit or define the disclosure, but to provide examples to aid understanding thereof. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying drawings, where:

FIG. 1 is a block diagram illustrating communication flows between computing devices in a segment analysis system for estimating changes in audience segment sizes over time, in accordance with embodiments;

FIG. 2 illustrates a module configured to support real-time and back end segment qualification, and near real-time audience size estimation, in accordance with embodiments;

FIG. 3 illustrates a module configured to implement near real-time audience size estimation over time, in accordance with embodiments;

FIG. 4 is an architecture diagram for a system configured to estimate changes in audience segment sizes over time, in accordance with embodiments;

FIG. 5 is a flowchart illustrating an exemplary method for real-time and back end segment qualification, in accordance with embodiments;

FIG. 6 is a flowchart illustrating an exemplary method for near real-time audience size estimation over time, in accordance with embodiments;

FIG. 7 illustrates an example block diagram of a system configured to implement the methods of FIGS. 5 and 6, in accordance with embodiments;

FIGS. 8A, 8B, and 9-20 illustrate interactive user interfaces and reports for an audience size estimation system, in accordance with various embodiments; and

FIG. 21 is a diagram of an exemplary computer system in which embodiments of the present disclosure can be implemented.

### DETAILED DESCRIPTION

Generally, the embodiments described herein are directed to, among other things, allowing users to estimate audience segment size changes over time in near real-time. For example, embodiments calculate the number of visitors that are in a given audience segment (e.g., an audience segment size), and calculate changes to the audience segment size over time. For example, given an audience segment of males living in San Jose, Calif., marketers and advertisers can use embodiments to determine the number of people in that segment and how that audience segment has changed over time. Embodiments facilitate providing this information to users such as marketers and advertisers in near real-time, while the users are creating a campaign (e.g., an advertising campaign) tailored to the given audience segment. Embodiments described herein can quickly calculate a time series of how an audience segment has changed over time. In addition to calculating past, historical audience segment size changes at different points in time, some embodiments can apply predictive analytics to predict or estimate how an audience segment will change in future. Quickly calculating the past and future audience segment size is critical for determining campaign performance, advertising expenditures (e.g., ad spend), and expected return on investment (ROI).

Embodiments pull out data points for historical data, and use predictive models, such as, for example time series projection model algorithms to predict audience segment sizes over time. In certain embodiments, past sizes of an audience segment are received as a time series of audience data points, and used to graphically depict the audience segment size over time. The depiction can include both past, historical segment sizes, and estimated future segment sizes. The estimated segment sizes can be determined using a predictive model. For example, after obtaining the history of an audience segment, time series prediction algorithms can be applied to the time series in order to project futures segment sizes at different points in time in the future. Time series analysis can be performed by analyzing time series data for a segment in order to extract statistics and other characteristics of the segment size over time. Time series forecasting can include using a model to predict future segment sizes based on historic, previously observed segment sizes at points in time in the past. Time series analysis of segment size data can include comparing values of a single time series or multiple dependent time series at different points in time. Non-limiting examples of time series prediction algorithms include linear regression polynomial regression, multiplicative/additive decomposition, linear trend with multiplicative additive seasonality, wavelet forecasting, Fourier transforms, and neural networks.

Certain embodiments project and predict an audience segment size based on calculated and determined patterns of past audience sizes, which are expressed as a time series. Some embodiments utilize services such as Adobe® Audience Manager Audience Size services to calculate not only a current audience segment size, but also a time series of changes for the audience segment size. This time series is in turn by an audience size estimating service that is configured to estimate the size of an audience segment in a near real-time. According to an example embodiment, recency-and-frequency segment definitions in a tool such as Adobe® Audience Manager can be utilized to calculate audience segment sizes in near real-time. For example, a frequency segment definition can be expressed as “freq(purchased over past 7 days)>3” to correspond to a segment that includes visitors that have made a purchase more than 3 time over the past 7 days. Embodiments can calculate audience sizes over time for such segments in near real-time.

In some embodiments, audience segment sizes are calculated based on retrieved audience data. For example, if a time range of interest spans into the future, audience segment sizes for a plurality of durations in the time range can be calculated using past audience data (e.g., numbers of viewers/visitors within a defined audience segment at different points in time in the past) to predict future audience segment sizes. According to embodiments, future audience segment sizes can be predicted based on patterns (e.g., cyclical changes tied to a time of day and/or a day of week, upward and/or downward trends) exhibited in retrieved audience data. In cases where the time range of interest does not span into the future, estimates of audience segment sizes for a plurality of durations in the past can be calculated based in part on the patterns in the retrieved audience data and actual audience segment sizes in the past.

According to an embodiment, an audience size estimator user interface (UI) is generated that displays audience size estimates and graphically depicts audience size predictions. The audience size estimate UI can depict estimated historic segment sizes for past time periods as well as predicted segment sizes for future time periods (e.g., past and future durations). In some embodiments, a segment builder UI is provided for creating and editing audience segments. As a marketer creates a segment in the segment builder UI, a graph of the number of people/visitors in that segment over time can be displayed in the audience size estimator UI. By using the audience size estimator UI, the marketer can also see the predicted change in the number of people (e.g., visitors) in the segment in the future. The systems and methods described herein can calculate and present this graph in near real-time.

As used herein, the term “electronic content” refers to any type of media that can be rendered for display or played on computing devices. Computing devices include client and server devices such as, but not limited to, servers, desktop computers, laptop computers, smart phones, video game consoles, smart televisions, tablet computers, portable gaming devices, personal digital assistants (PDAs), digital video recorders (DVRs), remote-storage DVRs, interactive TV systems, and other systems capable of receiving and displaying electronic content and/or utilizing a network connection such as the Internet. An exemplary interactive TV system can include a television communicatively coupled to set top box (STB). Electronic content can be streamed to, downloaded by, and/or uploaded from computing devices. Electronic content can include multimedia hosted on websites, such as web television, Internet television, standard web pages, or mobile web pages specifically formatted for display on computing devices. Electronic content can also include application software developed for computing devices that is designed to perform one or more specific tasks at the computing device.

Unless specifically stated differently, a “user” is interchangeably used herein to identify a user account, a human user, or a software agent. Besides a human user who accesses and uses electronic content such as web pages and online advertisements (e.g., ads), a software application or agent sometimes accesses electronic content. Accordingly, unless specifically stated, the term “user” as used herein does not necessarily pertain to a human being.

As used herein, the term “audience” refers to any set or segment of past, current, or potential users of electronic content. An audience can be visitors to a web site. As used herein, the term “segment” refers to any class of users of electronic content. For example, a segment can be a class of web site visitors. A class can be defined by a specific set of criteria or attributes. For example, a class of users of electronic content who are English-speaking male over age 30 can be a segment. An audience can comprise a group of consumers or visitors having profiles associated with them. The profiles can include user characteristics based on prior visits to web sites, a current visit to a particular web site, and/or a user identifier (i.e., a user ID). A cookie can be used to identify a user, consumer, or web site visitor as a member of an audience segment. Users having at least one common attribute, such as, for example a demographic attribute, can be part of an audience. For example, a segment of users sharing one or more demographic attributes, such as females over age 30, can be included in a ‘female-over 30’ audience. Audiences can be defined in terms of demographic data such as, for example, nationalities, spoken languages, residence addresses, and/or business addresses associated with users. For example, an audience segment of ‘young men in San Jose’ can be defined for users who are males between 18 and 25 years old who live and/or work in San Jose, Calif. Audiences can also be based on time-based attributes such as, for example, a time of day electronic content is accessed, a range of dates content is accessed, a day of week of access, a month during which content is accessed, and/or a season during which access occurs. An audience can be an intersection of two or more segments, such as, for example, males under age 26 in San Jose who access electronic content on a Sunday evening.

As used herein, a “campaign” refers to a collection of components, such as ads, and rules related to a marketing initiative or promotional effort. A campaign can be defined by an advertiser or ad agency based on who the advertiser wants to reach in terms of certain categories or types of viewers (e.g., audience segments), within a certain time period (e.g., durations, time ranges, date ranges, seasons), within a certain geographic region (e.g., cities, states, countries), a and/or a certain number of impressions for ads (e.g., a number of times ads in the campaign are served up to video players). Campaigns can include linear ads, overlay ads, and other ads such as, for example, hypervideo ads. Hypervideo advertisements can be embodied as displayed video streams containing embedded, selectable or actionable (e.g., user-clickable) anchors. Ad playback information for such hypervideo advertisements can include events corresponding to a selection or click of an anchor. Marketers and advertisers may be interested in knowing a predicted or estimated number of ad impressions for certain audience segments over time. For example, such audience size estimates can be used to tailor campaigns so that they are targeted in part to geographic regions included in certain time zones where video content and ads inserted into the video content will be placed. A campaign can include a set of rules defining what instances of components should be shown to whom, and when to show the instances. An exemplary campaign can include a plurality of instances of ads embodied as a set of alternative ads. In certain embodiments, for ads included in a campaign, all ad instances and offers are stored in that campaign along with the rules as campaign data. Various embodiments enable each offer in a campaign to be associated with a specific segment of users of electronic content (e.g., an audience segment). According to these embodiments, when a visitor arrives at a web page containing a targeted ad, the ad dynamically selects and displays an appropriate offer according to segment information for the visitor in accordance with rules defined for a campaign including the component. A given set of electronic content can include one or more ad that could be targeted (i.e., targetable ads). In certain embodiments, multiple campaigns can be applicable to that electronic content. According to these embodiments, each of these campaigns can include respective data for all of the variants of the targetable ads and actual content such as image, video and text assets comprising the ads. Campaign rules determine what will be displayed inside electronic content, such as a web page. Campaign data can include logic (i.e., targeting rules) for determining which ads are to be displayed to certain segments or audiences of users. Campaign data indicates target segments and audiences a campaign is interested in.

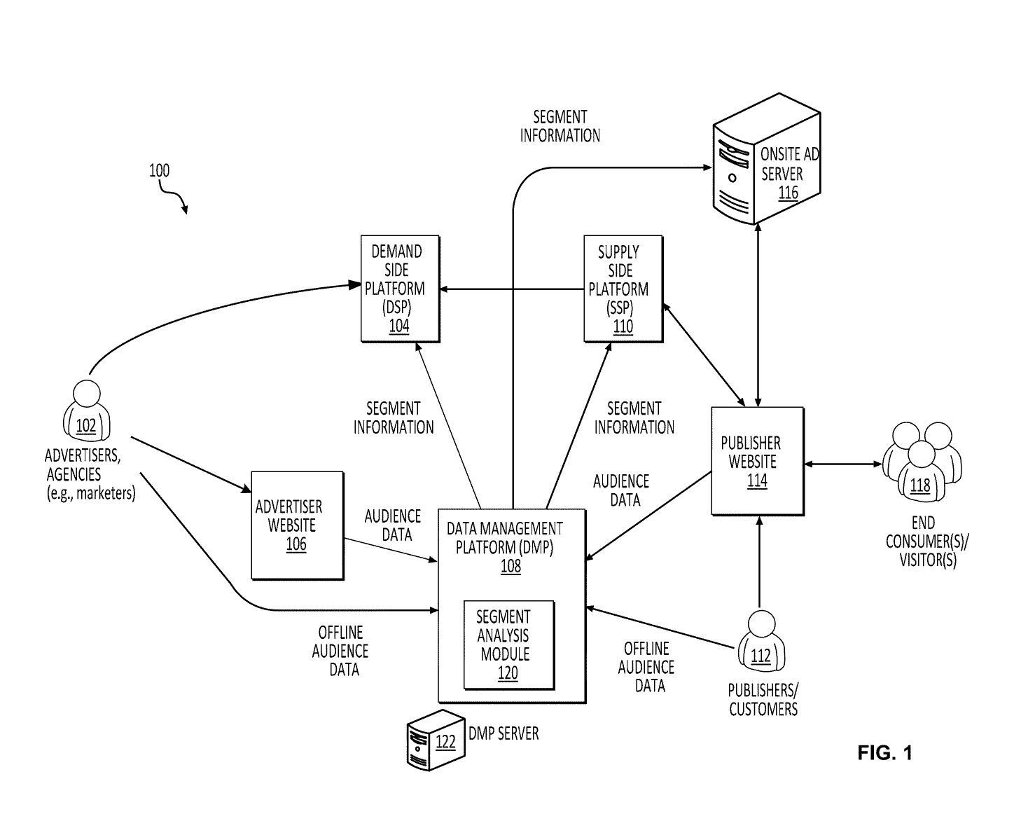

As used herein, the term “advertiser” refers to any potential purchaser or buyer of items from an inventory (i.e., ad slots) of a publisher. Advertisers can be ad agencies, marketers, or ad networks that supply and deliver ads. Advertisers may also be the originators of media buys, campaigns, and creatives. As shown in FIG. 1, advertisers/agencies 102 may be communicatively coupled (e.g., over a network) to demand side platform (DSP) 104 and data management platform (DMP) 108, where coupling to DMP 108 may be via advertiser website 106. In the example embodiment of FIG. 1, advertisers/agencies 102 may provide product content to advertiser website 106, where the product content may be presented for display and/or to generate a display. Advertiser website 106 may be network content owned by or otherwise associated with advertisers/agencies 102. Advertiser website 106 may collect data regarding visitors to the website and provide such data to DMP 108. Advertisers may make purchase decisions regarding where to place their ads based on their campaign goals and criteria. Advertisers can purchase placement for their ads, which can be stored in ad servers or in ad networks.

As used herein, the term “ad server” refers to an actual ad delivery system configured to deliver ads to visitors to a website. In various embodiments, an ad server delivers ads to be viewed on a publisher's website, such as publisher website 114 shown in FIG. 1. An exemplary onsite ad server 116 is described below with reference to FIG. 1. Certain embodiments can be used in conjunction with ad servers, systems and platforms such as, for example, the Adobe® Auditude video advertising platform, in order to enable advertisers and marketers to know whether an audience segment size is increasing or decreasing over time. For example, for ad campaigns that run for 30 days, advertisers and marketers need to know how the audience segment size changes to better predict their advertisements' performance over that 30-day period. Embodiments provide insight into how an audience segment is changing over time. For instance, an audience segment may be rapidly decreasing in size, and based on knowledge of this, marketers can adjust their campaign strategy so they do not fall short of campaign goals. By using embodiments to know how the segment size is changing before a campaign is run, marketers can make campaign adjustments early without having to first run a campaign for a short period of time. In this way, advertisers and marketers can adjust a campaign based on segment changes over time without having to use any ad funds (e.g., ad spend).

“First,” “Second,” etc. As used herein, these terms are used as labels for nouns that they precede, and do not imply any type of sequencing or ordering (e.g., spatial, temporal, logical, etc.). For example, for a segment analysis module evaluating the qualification of a visitor according to a segment rule that includes first and second visitor traits, the terms “first” and “second” visitor traits can be used to refer to any two visitor traits that are part of the segment rule. That is, the “first” and “second” traits are not limited to logical traits 0 and 1.

### Exemplary Systems, Modules and Architecture

Referring now to the drawings, FIGS. 1-4 illustrate exemplary segment analysis environments, systems, and architectures, as well as example segment analysis modules that may implement one or more of the disclosed real-time and back end (also referred to as processed) segment qualification techniques as well as near real-time audience segment size estimation. With reference to the examples of FIGS. 1-4, the following paragraphs describe techniques for performing real-time and back end segment qualification, and near real-time audience size estimation over time. Some exemplary techniques may be implemented, for example, by a segment analysis module or computer system.

While certain embodiments are described in terms of online advertising and marketing, similar techniques may apply in customer segmentation, content customization, and/or variable pricing of products and services.

Some embodiments can include a means for real-time and back end segment qualification and/or a means for audience size estimation using audience data shared between back end and real-time systems. For example, a segment analysis module (e.g., segment analysis modules 120, 218, and 313 of FIGS. 1, 2, and 3, respectively) are configured to determine that a visitor qualifies in a segment (by a real-time component, back end component or both) and, in an embodiment, store an indication of the visitor's segment qualification in the real-time component. As another example, the segment analysis module may receive selection of one or more traits or pixel qualification, create a segment rule that is usable to evaluate a combined recency and frequency of one or more qualification events, and evaluate the combined recency and frequency of the qualification events according to the segment rule. The segment analysis module may in some embodiments be implemented by a non-transitory, computer-readable storage medium and one or more processors (e.g., CPUs and/or GPUs) of a computing device. The computer-readable storage medium may store program instructions executable by the one or more processors to cause the computing device to determine whether a visitor qualifies in a segment (by a real-time component, back end component or both) and then store an indication of the visitor's segment qualification in the real-time component. The computer-readable storage medium may store program instructions executable by the one or more processors to cause the computing device to perform operations comprising receiving selection of a visitor trait, creating a segment rule usable to evaluate a combined recency and frequency of one or more qualification events, and evaluating the combined recency and frequency of the qualification events according to the created segment rule. Other embodiments of the segment analysis module may be at least partially implemented by hardware circuitry and/or firmware stored, for example, in a non-volatile memory.

In some embodiments, these techniques may be used in measuring the size of a segment audience, and in qualifying visitors in a segment. The segment audience size and visitor qualifications can then be used in an advertising campaign, email campaign, content customization, or for analytics purposes, among other example applications. Although certain embodiments and applications are described in terms of segment qualification, audience size estimation, and online advertising, it should be noted that the same or similar principles may be applied in other fields.

Moreover, although certain embodiments are described with respect to a webpage and/or website, it will be appreciated that the techniques disclosed herein may be employed with other forms of network content sites, such as documents with a traversable tree-like hierarchy (e.g., XML and HTML documents).

FIG. 1 illustrates an example segment analysis system 100 configured to support real-time and back end segment qualification and audience size estimation, in accordance with embodiments. As shown, segment analysis system 100 can operate in an environment including three primary entities/users of the system: advertisers/agencies 102, publishers/customers 112, and end consumers 118. End consumers 118 may also referred to as visitors, such as visitors to a website, viewers of electronic content, or visitors to other network content.

Advertisers/agencies 102 may be the buyers of ad impression opportunities for online advertising. They may also be the originators of media buys, campaigns, and creatives. In the example shown, advertisers/agencies 102 may be communicatively coupled (e.g., over a network) to demand side platform (DSP) 104 and data management platform (DMP) 108. Coupling to DMP 108 may be via advertiser website 106. In one embodiment, advertisers/agencies 102 may provide product content to advertiser website 106, where the product content may be presented for display and/or to generate a display. Advertiser website 106 may be network content owned by or otherwise associated with advertisers/agencies. Advertiser website 106 may collect data regarding visitors to the website and provide such data to DMP 108.

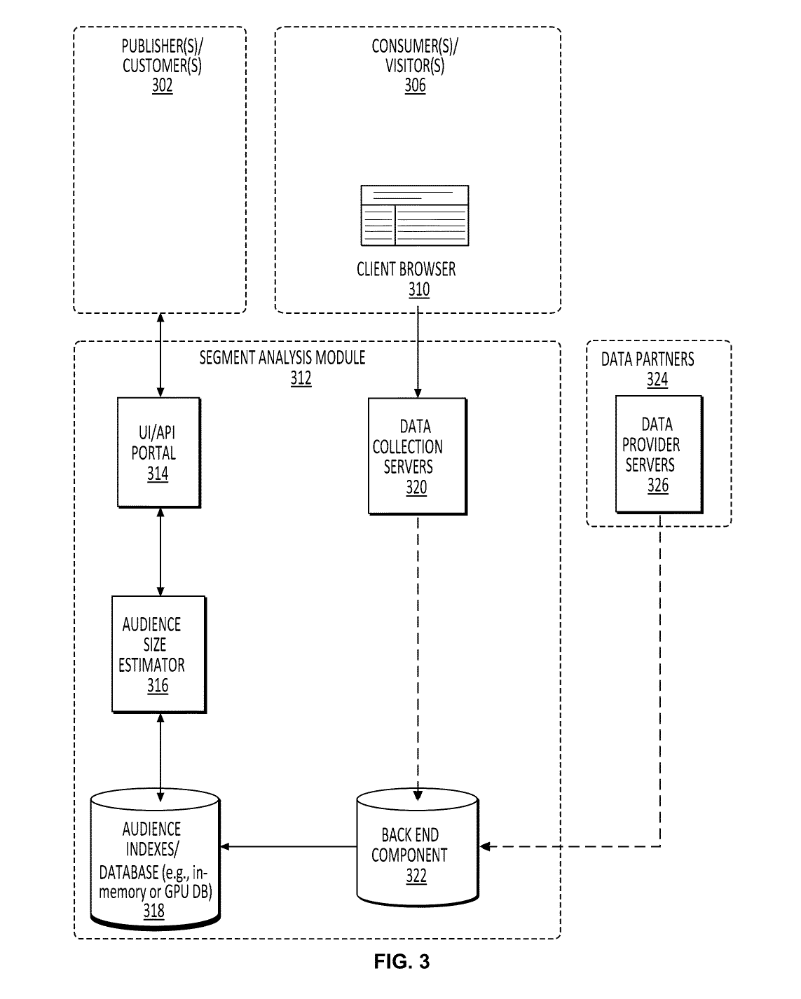

DMP 108 can include segment analysis module 120. Segment analysis module 120 may collect, aggregate, store, combine, and/or provide insights on audience behavioral and demographic statistics and data to advertisers/agencies 102 and publishers/customers 112. For example, segment analysis module 120 may determine real-time and back end segment qualification, and perform audience size estimation. The audience size estimation can be performed for a time series across multiple points of time in the past. DMP 108 can facilitate customers 112 easily ingesting data from multiple online and/or offline data sources. As shown, DMP 108 may receive offline audience data (also referred to as network content data) from advertisers/agencies 102 and/or publishers 112. Additionally, audience data may be collected at advertiser web site 106 and delivered to DMP 108. In some embodiments, DMP 108 may additionally or alternatively collect audience data from publisher website 114. Not shown in FIG. 1, but as described below with reference to FIG. 3, DMP 108 may also receive data from a third party data provider. DMP 108 may provide audience segment information (e.g., information indicative of segment qualification) to one or more of DSP 104, supply side platform (SSP) 110, and onsite ad server 116.

DSP 104 may be an advertising campaign management application which allows advertisers to manage their campaign/creative bidding rules, use audience data at scale and/or bid on available display advertising inventory. In one embodiment, advertisers/agencies 102 may provide ad campaigns, creative, and bid rules to DSP 104. In some embodiments, DSP 104 may be integrated with SSP 110 and perform ad exchanges via real-time bidding (RTB) server-to-server pipes. As shown in FIG. 1, DSP 104 and SSP 110 are separately illustrated. In various embodiments, DSP 104 may receive RTB ads from SSP 110.

In one embodiment, SSP 110 is a platform configured to aggregate publisher ad inventory supply and allow publishers 112 to leverage audience data for revenue optimization. As noted above, SSP 110 may be integrated with DSP 104 via RTB interfaces. In some embodiments, SSP 110 may receive a get ad request from publisher website 114 and in response, provide an ad, or facilitate provision of an ad, to publisher website 114 so that publisher website 114 can present the ad to end consumer/visitor 118.

Onsite ad server 116 may manage guaranteed advertising buys and ad insertions onto publisher pages. Examples include DoubleClick for Publishers (DFP) and Open Ad Stream (OAS). Onsite ad server 116 may receive a get ad request from publisher website 114 and provide an ad, or facilitate providing of an ad, to publisher website 114 to present to end consumer/visitor 118.

Publisher(s) 112 may include supplier(s) of ad inventory (e.g., available ad slots on pages). Publisher(s) 112 may send audience data in real-time to DMP 108 as end consumers/visitors 118 browse publisher web site 114. As described above, publisher(s) 112 may also provide offline audience data to DMP 108. In one embodiment, such offline audience data may be provided in bulk feed form.

Publisher website 114 may include network content, such as an automobile shopping website, a webmail website, etc. Publisher website 114 may be executable by a client device of end consumer/visitor 118. For example, the client device may include an application (e.g., an Internet web-browser application) that can be used to generate a request for content, to render the requested content, and/or to communicate requests to various devices on the network. For instance, in response to receiving a selection of a website link on a webpage displayed to consumer/visitor 118 or responsive to receiving a request to navigate to a uniform resource locator (URL) in a browser application, the browser application may submit a request for the corresponding webpage/content associated with the URL to a content server (not shown), and content server may provide corresponding content, including an HyperText Markup Language (HTML) file. The HTML file can then be parsed and executed by the browser application to render the requested website for display to the consumer/visitor 118. In some instances, execution of the HTML file may cause the corresponding webpage/content, such as publisher website 114 to provide real-time audience data regarding the web browsing of the consumer/visitor 118 to segment analysis module 120. While a webpage is discussed as an example of the network content available for use with the embodiments described herein, as would be readily apparent to one of ordinary skill in the art, other forms of electronic content, such as audio, image, or video files, may be used without departing from the scope and content herein disclosed. Likewise, while references herein to HTML and the hypertext transfer protocol (HTTP) protocol are discussed as an example of the languages and protocols available for use with the embodiments described herein, one of skill in the art will readily realize that other forms of languages and protocols, such as, but not limited to Extensible Markup Language (XML), file transfer protocol (FTP), Internet Protocol television (IPTV), real-time messaging protocol (RTMP), HTTP dynamic streaming (HDS), HTTP Live Streaming (HLS), and Dynamic Adaptive Streaming over HTTP (MPEG-DASH) may be used without departing from the scope and content herein disclosed.

Each of DSP 104, advertiser website 106, DMP 108, SSP 110, onsite ad server 116, and publisher website 114 may be communicatively coupled to one another via a network (not shown). The network may include any channel for providing communication between each of the entities of system 100. In an embodiment, the network may be a data communications network such as the Internet. In one or more embodiments, the network can be one of or a combination of networks such as Hybrid Fiber Coax, Fiber To The Home, Data Over Cable Service Interface Specification (DOCSIS), a Wide Area Network (WAN), WiFi, a Local Area Network (LAN), or any other wired or wireless network. The network may include a single network or combination of networks that facilitate communication between each of the entities (e.g., advertiser website 106, DMP 108, SSP 110, onsite ad server 116, and publisher website 114) of system 100. In some embodiments, various components of system 100 may be collocated (e.g., DSP 104 and SSP 110) as part of the same computing device or devices. In one embodiment, one or more of the components of system 100 may be remote from each other (e.g., hosted on or located on different computing devices connected over the network). In some embodiments, various components of system 100 may be cloud based. For example, one or more components of system 100 may be a virtual server implemented using multiple computing systems or servers connected in a grid or cloud computing topology. One or more of the servers in system 100 may have a single processor in a multi-core/multiprocessor system. Such a system can be configured to operate alone with a single server, such as server 116 or 122, or in a cluster of computing devices operating in a cluster or server farm. For example, one or more of DMP 108, DSP 104, and/or SSP 110 can be implemented on multiple computing devices. According to one such embodiment, DMP 108 may be implemented as a distributed system on a number of cloud nodes and on a number of servers.

While segment analysis module 120 is shown in FIG. 1 as a component of DMP 108, one of skill in the art will readily realize, in light of having read the present disclosure, that segment analysis module 120 may be embodied in a separate system with access to data received by DMP 108, such as offline and/or real-time data, via the network.

Audience data, whether real-time or offline audience data (e.g., first party or from a third party data provider), may include a variety of information, such as cookies, hits, page views, visits, sessions, downloads, first visits, first sessions, visitors, unique visitors, unique users, repeat visitors, new visitors, impressions, singletons, bounce rates, exit percentages, visibility time, session duration, page view duration, time on page, active time, engagement time, page depth, page views per session, frequency, session per unique, click path, click, site overlay, behavioral traits, user intents, user interests, demographic data, etc. The various data may describe usage and visitation patterns for websites (e.g., publisher website 114, advertiser website 106, etc.) and/or individual webpages within the website. The various data may include information relating to the activity and interactions of one or more users/visitors with a given website or webpage. For example, audience data may include historic and/or current website browsing information for one or more website visitors, including, but not limited to identification of links selected, identification of web pages viewed, related content topics, and other data that may help gauge user interactions with webpages/websites.

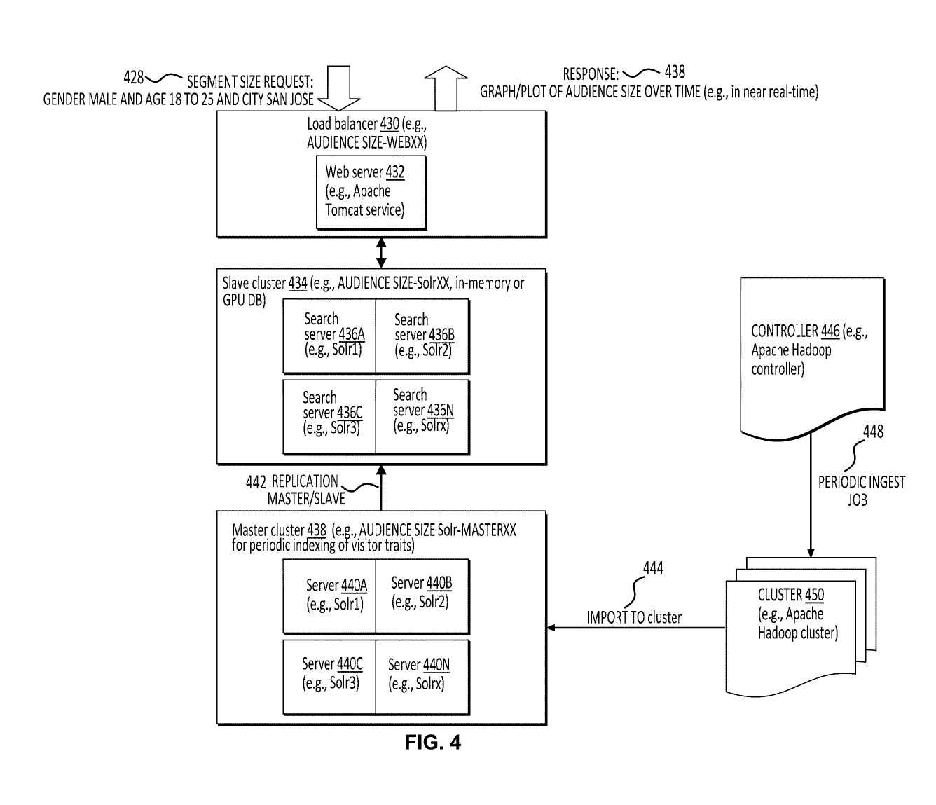

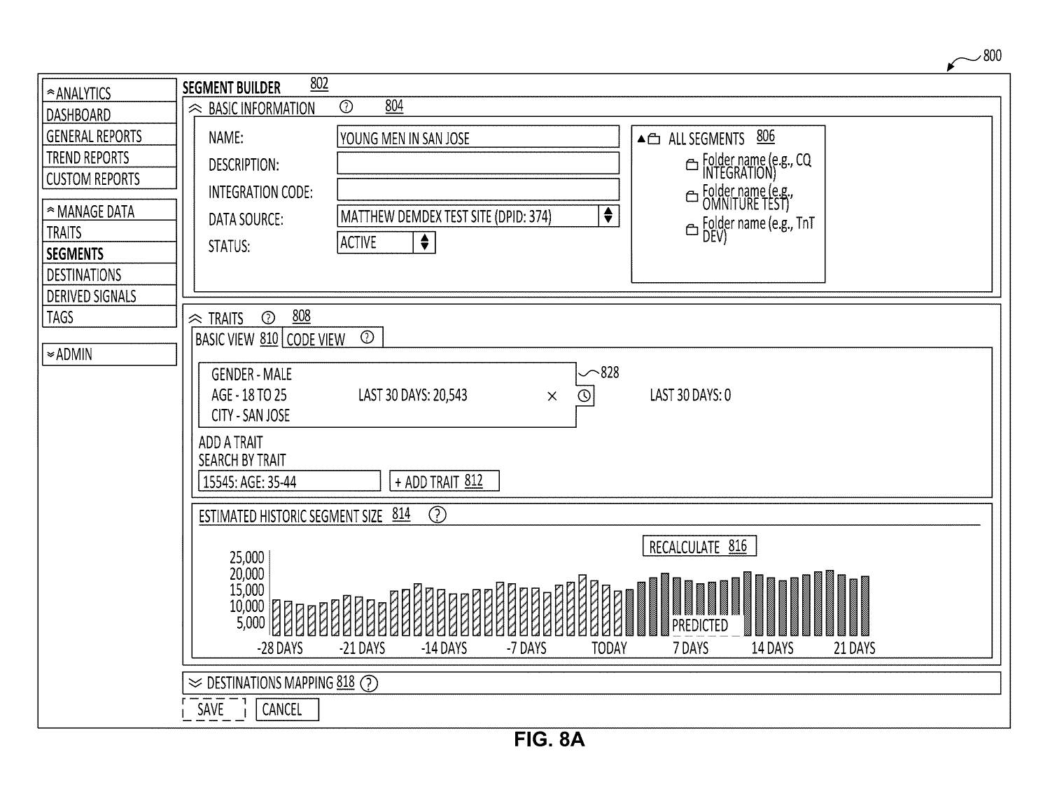

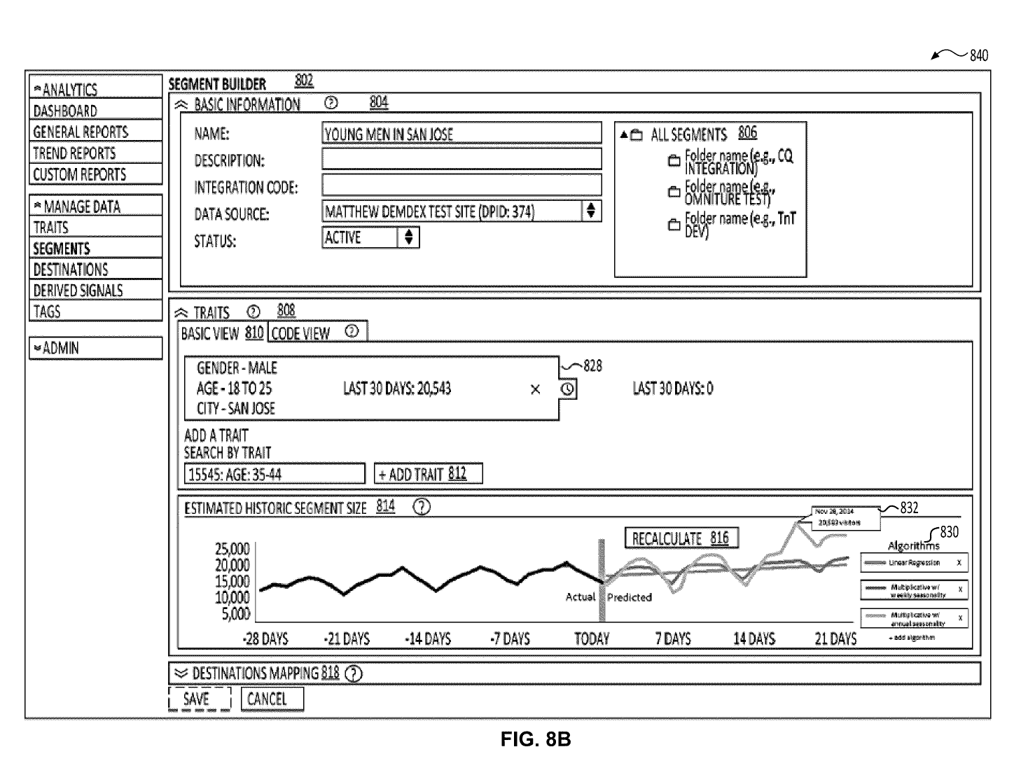

In some embodiments, audience data may include information indicative of a location associated with audience members. For example, audience data may include location data indicative of a geographic location of the client device of consumer/visitor 118. Non-limiting examples of these embodiments are shown in FIGS. 4 and 8 where an audience segment is defined in part by consumers/visitors in San Jose. In some embodiments, location data may be correlated with corresponding user activity. In certain embodiments, location data includes geographic location information. For example, location data may include an indication of the geographic coordinates (e.g., latitude and longitude coordinates), IP address, media access control (MAC) address, or the like or a consumer/visitor 118 or a device associated with the consumer/visitor 118. In some embodiments, audience data may include demographic information indicative of the consumer/visitor 118, such as for example, a gender, age, marital status, and/or income level of the consumer/visitor 118. Examples of such embodiments are shown in FIGS. 4 and 8 where an audience segment is defined in part by male consumers/visitors in the 18-25 year age range.

In some embodiments, audience data is accumulated over time to generate a set of audience data (e.g., offline audience data) that is representative of activity and interactions of one or more users with a given website or webpage. In one embodiment, such an accumulation may be performed by various publishers/customers with respect to audience data generated through web sites/network content that the publishers/customers own. In one embodiment, such an accumulation may be performed by third party data providers.

The data (e.g., real-time and/or offline) may be used to qualify visitors in a segment, according to the disclosed techniques, and/or to perform real-time audience size estimation for a segment. Such a qualification of a visitor may be usable to select an ad to display to consumer/visitor 118. Audience size estimation may be usable to evaluate a worth of a segment. For example, if the segment is sufficiently large, then it may be worth commencing a new advertising campaign or continuing an existing one. Conversely, if the segment is small, then it may not be worth commencing a new advertising campaign directed toward that segment or it may be determined that a new outreach campaign should be commenced to increase the size of the segment.

In some embodiments, segment analysis module 120 may include computer executable code (e.g., executable software modules) stored on a computer readable storage medium that is executable by a computer to provide associated processing. For example, segment analysis module 120 may process real-time and/or offline audience data to perform the techniques described herein.

In some embodiments, a customer/publisher/content provider 112 may log-in to a website or some other user interface/network portal, for example, hosted by DMP 108, and may interact with audience data to create, modify, and/or apply a segment rule. The segment rule may then be usable to determine an audience size and/or qualify visitors in real-time or as an offline back end qualification. Such determinations may be usable to select and place an online ad for one or more visitors.

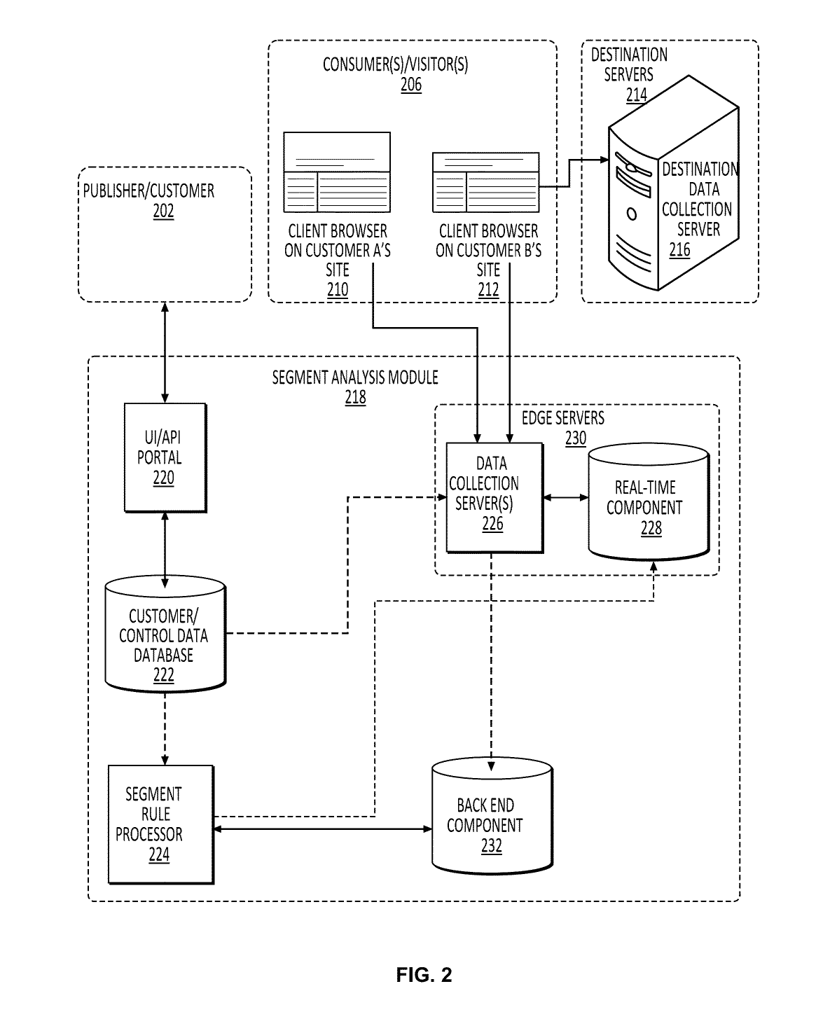

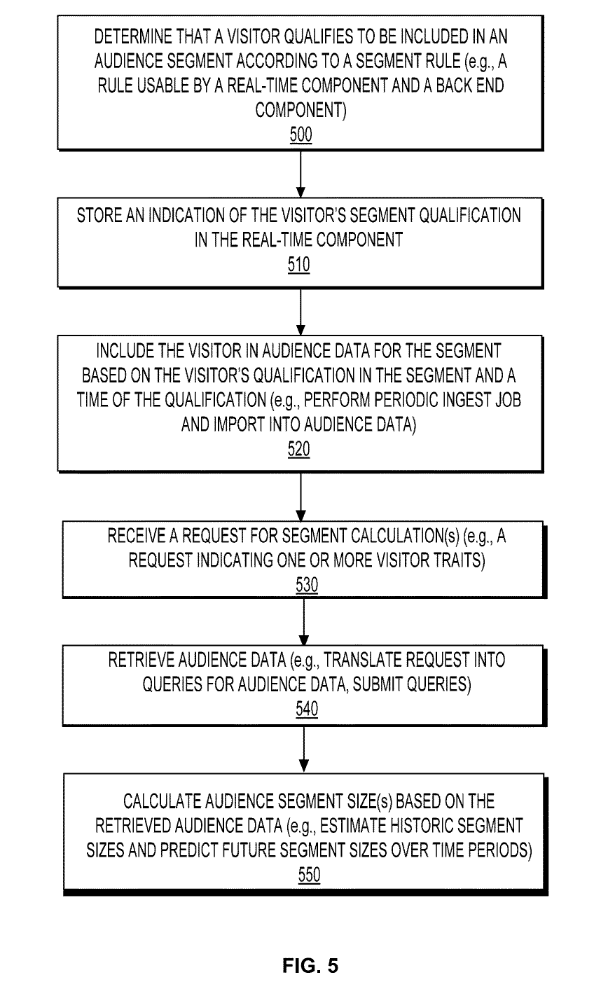

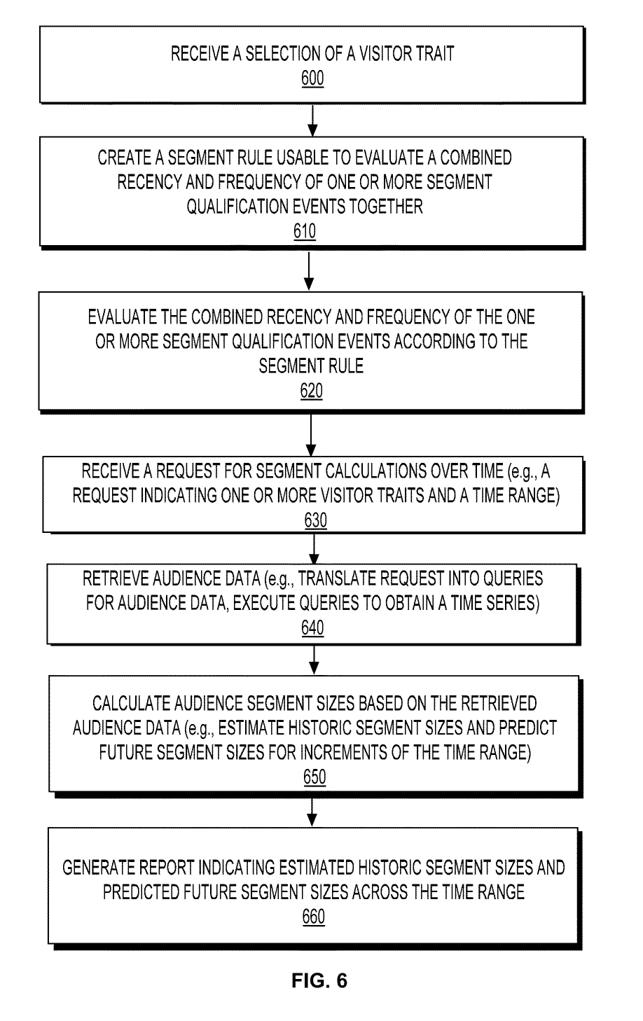

FIG. 2 depicts a module configured to implement real-time segment processing and back end segment processing, according to some embodiments. Segment analysis module 218 (which may be the same module as segment analysis module 120 of FIG. 1) may, for example, implement one or more of the techniques described below with reference to the flowcharts of FIGS. 5 and 6. It is to be understood that the segment analysis modules shown in FIGS. 1-3 may refer to the same segment analysis module and may implement portions of any or all of the disclosed techniques.

Segment analysis module 218 can receive, via user interface/application programming interface (UI/API) portal 220 from publisher/customer 202, input that defines a segment rule. Such input may be provided via touch-screen, mouse, keyboard, or other suitable device. Such input can comprise selection of one or more visitor traits, Boolean operator(s), recency/frequency requirements, and/or destination rules, among other inputs. A visitor trait may correspond to a single data collection event from received audience data that is descriptive of a visitor of network content. Example visitor traits can include, but are not limited to a gender (e.g., male or female), a geographic area (e.g., living or working in San Jose), an age range (e.g., 18-25 years old), an expensive camera shopper/buyer, high-end car shopper/buyer, laptop shopper/buyer, etc. For example, the expensive camera shopper trait may correspond to data collection events indicative of browsing for a camera over $500. Based on the received input, a segment rule may be created. The inputs and/or segment rule may persist in customer/control data database 222. Customer/control data database 222 may provide customer segment and destination rules as an asynchronous feed to data collection server(s) 226 of edge servers 230 and segment rule processor 224. Segment rule processor 224 may interface with both real-time component 228 and back end component 232 such that the same segment rule may be used by either or both components. In the exemplary embodiment shown in FIG. 2, segment rule processor 224 is configured to provide URL destinations, which are based on audience segments determined by back end component 232, to real-time component 228. Data collection server(s) 226 may receive and send destinations from and to real-time component 228. Data collection server(s) 226 may also send an asynchronous data aggregation feed of traits and real-time determined segments to back end component 232 for storage in a data store of back end component 232. Data collection server(s) 226 may also receive first party data via HTTP data collection requests from client browsers 210 and 212, which may be executed on client devices of consumers/visitors 206. Segment analysis module 218 may also receive third party data. Such third party data can be received from data partners (see, e.g., data partners 324 of FIG. 3). Although third party data is illustrated in FIG. 3 as being provided to segment analysis module 312 by data provider servers 326, it is to be understood that such third party data can also be provided to the segment analysis module 218 shown in FIG. 2. It is to be further understood that other components not shown in both of FIGS. 2 and 3 may exist in both figures, but that for simplicity of drawing and explanation, these are omitted.

Segment analysis module 218 may then perform the techniques described below with reference to FIGS. 5 and 6 on the received data (e.g., first party from the customer's website and/or third party data) based on the segment rule. For example, either or both of real-time component 228 and back end component 232 may determine that a visitor qualifies in a segment according to the same segment rule, as described herein. Segment analysis module 218 may generate, as output, a destination call to network content (e.g., customer B's web site in the illustrated example) such that an HTTP destination URL call may be requested from destination-data collection server 216 of destination servers 214. Segment analysis module 218 may also generate, as output, a report regarding segment audience size, qualifications, or other reports, which may be displayable via UI/API portal 220 and/or stored to a storage medium (not shown), such as system memory, a disk drive, DVD, CD, etc.

FIG. 3 depicts a module that may implement audience size estimation (e.g., real-time) using combined recency and frequency, according to some embodiments. Segment analysis module 312 may, for example, implement one or more of the methods described below with reference to FIGS. 5 and 6. The segment analysis modules of FIGS. 1-3 may refer to the same segment analysis module and may implement any or all of the disclosed techniques.

Segment analysis module 312 may receive input, via UI/API portal 314, from publisher/customer 302. Such input may be provided via touchscreen, mouse, keyboard, or other suitable device. As described herein, the input may include one or more traits, Boolean operator(s), recency/frequency requirements, and/or destination rules, time ranges, among other inputs. Based on such input, a segment rule may be created and/or an audience may be defined. In an audience size determination application, a synchronous query for audience size may be sent from UI/API portal 314 to audience size estimator 316 and a real-time determination of the audience size may be provided from audience size estimator 316 to UI/API Portal 314. A similar synchronous query and result can also take place between audience size estimator 316 and audience indexes/database 218.

Back end component 322 may receive, via an asynchronous data aggregation feed from data collection servers 320, first party data via HTTP data collection requests from client browser 310, which may be executed on a client device of consumers/visitors 306. Back end component 322 may also receive third party data from data provider servers 326 of data partners 324. Third party data may be received as a bulk asynchronous feed. Back end component 322 may then provide visitor/trait data from the first and third party data in an asynchronous feed to audience indexes/database 318, upon which the data may be used to determine audience segment size, as described herein. In an embodiment, the audience indexes/database 318 can be implemented as an in-memory database for performance reasons.

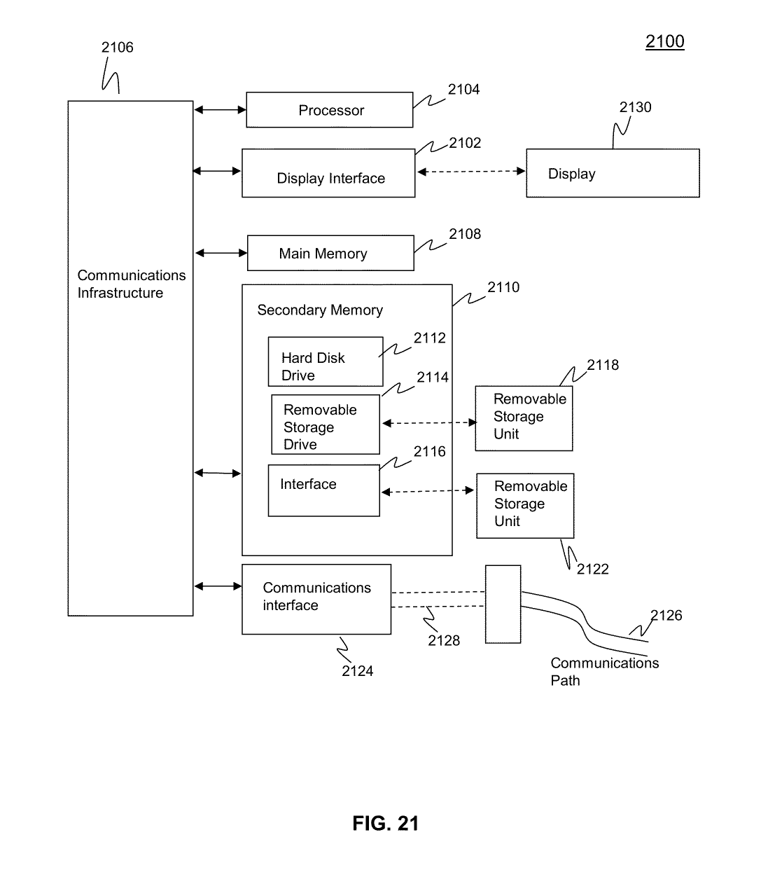

Segment analysis module 312 may then perform the methods described below with reference to FIGS. 5 and 6 on the received data (e.g., first party from the customer's website and/or third party data) based on the segment rule. For example, real-time audience size estimation may be performed according to the segment rule, which may include combined recency and frequency, as described herein. Segment analysis module 312 may generate, as output, a destination call to network content such that an HTTP destination URL call may be requested. Segment analysis module 312 may also generate, as output, a report regarding segment audience size, qualifications, or other reports, which may be displayable via UI/API portal 314 and/or stored to a storage medium, such as system memory, a disk drive, DVD, CD, etc. (see, e.g., main memory 2108, secondary memory 2110 and its hard disk drive 2112 and removable storage drive 2114 in FIG. 21). Examples of such reports are shown in the exemplary interfaces of FIGS. 8 and 16-20.

FIG. 4 illustrates an example architecture of a system for estimating audience segment sizes. As shown, the architecture consists of a web server 432 behind a load balancer 430. In the non-limiting example of FIG. 4, web server 432 is implemented as an Apache Tomcat web service. These and comparable web services are configured to take a segment indicated in incoming request 428 and return a response 438. As shown, response 438 can include a graph of the segment size that is provided by the architecture of FIG. 4 in near real-time.

With continued reference to FIG. 4, below the web server 432, is slave cluster 434. As shown, slave cluster 434 can be implemented as a cluster of servers. The cluster can include slave servers 436A-436N. In the example of FIG. 4, slave servers 436A-436N can be Solr servers. As also shown, the servers can be implemented using an in-memory database or a GPU database. The cluster is configured to index visitor traits. For instance, a visitor with the traits of male, ‘age 18-25’ and ‘lives in San Jose’ can becomes an indexable document in the cluster. The speed and performance of the system is due to the ability of the cluster to perform queries rapidly. For example, Solr servers can support enterprise search platform features such as distributed searching, replication (including index replication), full-text searching, hit highlighting, faceted searching, dynamic clustering, integration with databases, and document handling.

The architecture further includes a master cluster 438 of servers 440A-440N. As shown in FIG. 4, master cluster 438 can be implemented as another Solr cluster. Master cluster 438 can used to periodically index the visitor traits. In one embodiment, master cluster 438 indexes the visitor traits daily. In other embodiments, master cluster 438 indexes the visitor traits more frequently or less frequently, in accordance with a user-selected tunable indexing parameter. Slave cluster 434 is configured as a slave to master cluster 438 and replication 442 is performed to synchronize data and indexes between master cluster 438 and slave cluster 434.

Periodically (e.g., daily), a controller 446 sub-samples a set of visitors and inserts their traits into master cluster 438. The visitor traits are indexed by the time/date they occurred. A periodic ingest job 448 is used to insert the data into a cluster 450. As shown, controller 446 and cluster 450 can be implemented using an Apache Hadoop framework. The Hadoop framework can facilitate storage and large-scale processing of data sets on clusters of servers. After the trait data is inserted into cluster 450, master cluster 438 can do an import 444 to import the data.

Embodiments using Solr servers as slave servers 436A-N and/or master servers 440A-N can utilize an expressive query language supported by Solr servers. According to these embodiments, web server 432 can be configured to translate the audience segment definitions indicated in segment size request 428 into a set of Solr queries. For example, the audience segment (genderMale AND livesInSanJose) can be translated into the Solr query: (genderMale_<1dayAgo>:* or genderMale_<2daysAgo>:* or genderMale_<3daysAgo>:*) and (livesInSanJose_<1 dayAgo>:* or livesInSanJose_<2daysAgo>:* or livesInSanJose:<3daysAgo>). When this query is sent to slave cluster 434, the architecture will return the number of visitors that are in the segment for a given period (e.g., a given day). To obtain the time series, multiple queries are submitted.

Web server 432 is used to convert the audience segment indicated in request 428 into multiple queries (e.g., multiple Solr queries or multiple queries for an in-memory database). Although only a single web server 432 is depicted in FIG. 4, it is to be understood that the architecture can include multiple web servers 432. Web server 432 can also be used to concatenate all the individual requests 428 into a time series. Once slave cluster 434 (e.g., Solr cluster) has the time series, a predictive algorithm can be applied to predict how the audience size will change in the future. In this way, the predicted, future audience sizes shown in the example interfaces of FIGS. 8A and 8B can be presented together with estimated historic segment sizes over past time periods (e.g., past durations such as past days or hours).

Exemplary Methods

FIGS. 5 and 6 are flowcharts illustrating exemplary methods for determining and estimating audience segment sizes over time. Such exemplary methods may be performed on a variety of computer devices the computing devices, platforms, servers, and server clusters described above with reference to FIGS. 1-4. For example, one or more operations and steps shown in FIGS. 5 and 6 may be performed by computing devices including, but not limited to, servers 116, 122, 214, 216, 320, 326, 432 of FIGS. 1-4, and the computing system 2100 of FIG. 21. For purposes of illustration and not limitation, the features of the exemplary methods shown in FIGS. 5 and 6 are described with reference to elements of FIGS. 1-4.

FIG. 5 is a flow chart illustrating an example method for real-time and back end segment qualification and calculation of segment sizes. While the blocks are shown in a particular order for ease of understanding, other orders may be used. In some embodiments, the method of FIG. 5 may include additional (or fewer) blocks than shown. Blocks 500-550 may be performed automatically or may be performed responsive to receiving an input. In one embodiment, the segment analysis module of FIGS. 1-3 and the architecture of FIG. 4 may implement the method of FIG. 5.

The method begins at block 500 when it is determined that a visitor qualifies to be included in an audience segment according to a segment rule. This step can include evaluating network content data. Network content data may include audience data, such as, but not limited to, real-time audience data and offline audience data. In certain embodiments, at least a portion of the network content data can be received from a third party data provider. For example, various network content sites can provide data about visitors to the sites to a third party data provider, who in turn can aggregate that data and provide it to the segment analysis module.

In one embodiment, at least a portion of the network content data that is received from the third party data provider may be matched with at least some other of the network content data that is associated with the visitor's visit to the first network content. The result of the matching may be matched data. Determining that the visitor qualifies in the segment may be based on the matched data. As an example of matched data, a visitor may have logged into network content under a profile associated with the visitor (e.g., logged into a social networking website, shopping website, forum, etc.) or may have entered data into an online form. Data created during the visit and logging in under a profile or entering information into an online forum may include demographic information (e.g., name, age, gender, occupation, etc. Data created during that visit may also include a visitor identifier (e.g., an IP address, a MAC address, a unique visitor ID, etc.) associated with the visitor. The data from the third party provider may also include the same visitor identifier thereby allowing data having the same visitor identifier to be matched. As an example, it may be known that visitor A is male because he logged in under his profile to a social networking site. Third party provider may have data from months ago that includes the visitor's IP address that matches the visitor's IP address from where the visitor logged in to the social networking website. Therefore, the data from the third party provider may then be determined as corresponding to a male visitor.

As shown in FIG. 5, the same segment rule in block 500 may be used in both the real-time component and the back end component. For example, the segment rule may be usable by the real-time component, during the visitor's visit to first network content (e.g., the website of a first customer), to determine that the visitor qualifies in the segment. The segment rule may also be usable by the back end component to determine that the visitor qualifies in the segment. In some embodiments, determining that the visitor qualifies in the segment may be performed by the real-time component, back end component, or both. In one embodiment, determining that the visitor qualifies in the segment may be performed by the back end component after the visitor has completed visiting the first network content (e.g., visiting second network content or after the visitor's browser is closed).

Evaluating network content data by the backend component may include performing a full table scan on an HBase cluster (or comparable data store) that stores billions of visitor profiles. Each profile includes network content data associated with one of the visitors. Moreover, evaluating network content data (by the real-time and/or back end) may include evaluating the network content data for all of the active segment rules. Note that many segment rules may exist at once but for ease of explanation, much of the description focuses on a single segment rule. In various embodiments, evaluating network content data may be performed periodically (e.g., hourly, daily, weekly, etc.) by the back end component. Periodic evaluations may result in updated visitor qualifications based on a new, updated, or changed segment rule, or based on new data that allows a visitor to be qualified under the segment rule.

In some embodiments, at least a portion of the network content data, which is evaluated according to the segment rule, may be associated with the visitor's visit to first network content.

In certain embodiments, determining that a visitor qualifies in the segment may be performed after or in response to a change to a previous segment rule. For example, the previous segment rule may have defined a male, high-end car segment as a visitor who is male and has visited a site related to a high-end car (e.g., a car with a manufacturer suggested retail price/MSRP>$50,000), and has visited such a web site (or distinct webpages) five times in the previous three days. The updated segment rule may lower the threshold of high-end car to MSRP>$40,000. Accordingly, qualification of the visitor in the segment may be determined automatically in response to the update to the segment rule or it may require user input to determine qualification under the updated segment rule.

In some embodiments, the segment rule may be created after the visitor has completed visiting the first network content. For example, similar to the example above, a segment rule for a male, high-end car segment may be created after the visitor has already visited a high-end car web site the requisite number of times to qualify in the segment. Moreover, the segment rule may be created after the visitor has left the first network content such that the visitor is not actively browsing the first network content. Accordingly, the visitor may be qualified, for example, by the back end component, after such a visit to the network content is complete by using the newly created segment rule and offline data (e.g., first party from the customer who owns the first network content or from a third party data provider, etc.).

In some embodiments, a visitor may qualify in a segment based entirely on third party provided data. Such embodiments may permit a customer to target an ad to a visitor who has never visited a website associated with the customer. In other embodiments, first party data (e.g., from the visitor's visit to a website), third party data, or some combination of first and third party data may be used to qualify the visitor in a segment.

In one embodiment, the same segment rule and same code libraries may be shared across both the real-time component as well as the back end component application. The code libraries may exist on each of the data collection servers of the real-time components and also on a plurality of nodes of the back end components. In one embodiment, the back end component application may be a Map-Reduce application implemented in Java. The same core logic may be used in both the real-time and back end components. The data storage layer for the real-time component, though, may be different than the data storage layer for the back end component. In the case of the real-time component, the data storage layer may be a combination of visitor cookie data as well as behavioral trait data stored in the real-time profile cache server (PCS) machines. In one embodiment, the data storage layer for the back end component may be a distributed data store implemented in the cloud, such as an HBase cluster of open source, non-relational, distributed databases.

At 510, an indication of the visitor's segment qualification may be stored in the real-time component. In an embodiment where determining that the visitor qualifies in the segment is performed by the back end component, storing the indication may include the back end component providing the indication to the real-time component. Note that an indication of each segment that the visitor qualifies for may be stored in the real-time component. For example, a visitor may qualify for multiple segments, each of which may be represented in the real-time component by an indication of the qualification. After the visitor's segment qualification is stored, control is passed to block 520.

In block 520, the visitor is included in audience data for the segment. This inclusion is based at least in part on the visitor's qualification in the segment and a time of the qualification. As shown, this step can be accomplished by performing a periodic ingest job (e.g., a daily job) and importing the ingested data into the audience data (e.g., via import 444 into a cluster). For example, block 520 can comprise periodically using controller 446 to sub-sample a set of visitors and inserting their traits into master cluster 438. The visitor traits can then be indexed by the time and date they occurred. Periodic ingest job 448 can be run as part of block 520 to insert the data into cluster 450. After the trait data is inserted into cluster 450, master cluster 438 can do an import 444 to import the data.

Next, at block 530, a request for segment size(s) is received. As shown in FIG. 5, this request can indicate one or more visitor traits. In response to receiving the request, control is passed to block 540.

At block 540, audience data is retrieved. As shown, this step can comprise translating request received at block 530 into queries for audience data and then submitting the queries. In an embodiment, Web server 432 is used at block 540 to convert the audience segment indicated in the request into multiple queries (e.g., multiple Solr queries). In an additional or alternative embodiment, web server 432 can also be used in block 540 to concatenate all individual requests received at block 530 into a time series.

At this point, in block 550, audience segment sizes over time are calculated based on the audience data retrieved at block 540. As depicted in FIG. 5, block 550 can comprise estimating historic segment sizes and predicting future segment sizes over time periods across a time range. For example, block 550 can include using the retrieved audience data to estimate segment sizes in daily increments going back in time several weeks in the past relative to the current day. Also, for example, block 550 can further include using a time series of the retrieved audience data to predict daily segment sizes in daily increments going weeks into the future from the present day. For instance, once slave cluster 434 (e.g., a Solr cluster) has the time series retrieved at block 540, a predictive algorithm can be applied to predict how the audience size will change in the future.

Turning now to FIG. 6, one embodiment of real-time audience size estimation over time is illustrated. While the blocks are shown in a particular order for ease of understanding, other orders may be used. In some embodiments, the method of FIG. 6 may include additional (or fewer) blocks than shown. Blocks 600-660 may be performed automatically or may be performed in response to receiving user input. The method of FIG. 6 may be used in conjunction with the method of FIG. 5. Accordingly, a combination of some or all of the operations and steps of FIGS. 5 and 6 may be used in some embodiments. In one embodiment, the segment analysis module of FIGS. 1-3 and architecture of FIG. 4 may implement the method of FIG. 6.

As shown at block 600, a selection of a visitor trait may be received. As described herein, the visitor trait may be descriptive of visitors of network content. Example traits can include, but are not limited to, male, car buyer, between ages 18 and 25, living in San Jose, interested in laptops, etc. Selection of a visitor trait may be received via a user interface or portal, for example, from a customer associated with network content. Example user interfaces are shown in FIGS. 8A, 8B, and 9-20, which are described below. In some embodiments, selection of other traits that are also descriptive of visitors of network content may be received. For example, selection of any number (e.g., three, five, seven, etc.) of traits may be received. After the visitor trait is selected, control is passed to block 610.

At block 610, a segment rule may be created that is usable to evaluate a combined recency and frequency of one or more qualification events together. The qualification events may indicate qualification of a visitor according to a trait. The one or more qualification events may be based on collected network content data (e.g., audience data) associated with a plurality of visitors. Each of the one or more qualification events may correspond to qualification of a separate portion of the collected network content data according to the trait.

In contrast to a system that separately evaluates recency and separately evaluates frequency, evaluating a combined recency and frequency of one or more qualification events together may include evaluating a number of qualification events over a defined period of time (e.g., the visitor qualified x times over the past y days). A system that separately evaluates recency and frequency may evaluate a most recent event and separately evaluate a frequency counter of the event (e.g., the visitor qualified x times total and qualified once in the past y days). The following example illustrates the difference. Consider a scenario in which visitor A has visited a high-end car website once a month for the past five months with the most recent visit occurring two days ago. At block 610, a segment rule may be created that defines a high-end car buyer segment as someone who has visited a high-end car website five times in the past three days. Visitor A, who has visited such a website once a month for the past five months with the most recent visit being two days ago, would not qualify according to the five times in the past three days combined recency and frequency segment rule. However, in a system that considers the recency and frequency separately, visitor A would qualify under frequency as having visited a high-end car website five times total and would also qualify under recency because they visited a high-end car website two days ago. Marketers are often interested in the intensity with which visitors are associated with a visitor trait. Evaluating the combined recency and frequency may reflect the intensity, whereas separate recency and separate frequency does not reflect such intensity. In the preceding example, visitor A is not associated with very much intensity, and therefore may be viewed, by marketers and advertisers, as a casual browser of the high-end car website rather than a serious shopper for or consumer of high-end cars.

In accordance with an embodiment, each of the one or more qualification events may be associated with a time of occurrence of the respective qualification event. Each time of occurrence may be stored with an indication of the respective qualification event, as opposed to a system that only stores the most recent timestamp of a qualification event. Such times of occurrence may be usable in generating a time series of audience data for a segment. Such times of occurrence may also be usable in evaluating the combined recency and frequency according to the segment rule.

In certain embodiments, an indication of each of the one or more qualification events may be stored (e.g., in a data store). In some embodiments, the data store may be local to the real-time component, such as in a data store that is quickly accessible (e.g., an in-memory database, a GPU database, or a data cache). In some embodiments, the indication may be stored in the back end component in addition to or instead of storing the indication local to the real-time component.

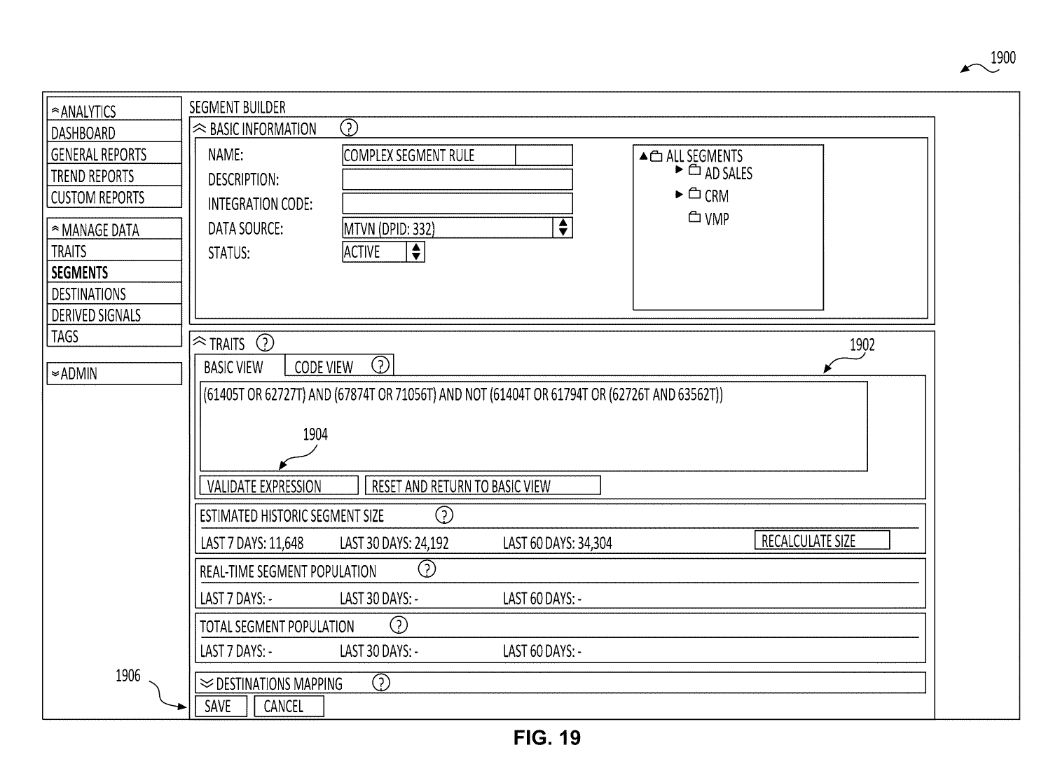

In an embodiment in which multiple visitor traits are selected, a selection of an operator for the segment rule may be received. The operator may be for a Boolean expression that includes the trait and another trait. For instance, the segment rule may include one or more instances of the operators AND, OR, NOT AND, or NOT OR. For example, a segment rule may be male AND 18-25 years of age AND living in San Jose AND a high-end camera buyer. The combined recency and frequency discussed above may be applied across one or more of the multiple visitor traits, such as, for example, the high-end camera buyer trait. Moreover, an audience segment rule having Boolean expressions may have such Boolean expressions in addition to or instead of combined recency and frequency. Thus, in certain embodiments, a segment rule may not use the described combined recency and frequency. Instead, these embodiments may use one or more Boolean expressions, such as, for example, male AND 18-25 years of age AND living in San Jose. Further, for example, an audience segment rule can be defined for a high-end camera buyer AND high-end car buyer. The combined recency and frequency can be applied to either high-end camera buyer, high-end car buyer, or both traits. According to some embodiments, the segment rule may be an n-level deep nested Boolean expression. Such an example is illustrated in trait code view 1902 of FIG. 19.

As illustrated at 620, the combined recency and frequency of the one or more qualification events can be evaluated according to the segment rule. Evaluating the qualification events according to the segment rule may include reading the qualification events from the data store, which may include reading a respective time of occurrence of the respective qualification events. In one embodiment, evaluating the qualification events according to the segment rule may include estimating the segment population size based on the stored indications of each of the one or more qualification events. Such estimating can be performed as part of block 650, which is described below.

In accordance with embodiments, an ad to be provided to the visitor of network content may be determined as part of block 620. The specific ad chosen can be selected by an ad server (e.g., onsite ad server 116). In other instances, the segment analysis module may select the ad or simply provide an instruction that indicates which segments a visitor qualifies for. That instruction may be accompanied with indications of which ads a particular visitor has already seen such that any ad viewing limits may be respected. The evaluating of block 620 may result in the visitor qualifying for a segment being associated with a particular ad.

After the combined recency and frequency of the qualification events are evaluated, control is passed to block 630.

At block 630, a request for segment size(s) is received. As depicted in FIG. 6, this request can indicate one or more visitor traits and a time range. The time range can be a time range of interest to a user that is specified in a user interface. For example, the user may indicate in the request that audience segment sizes are requested for daily increments going back in time 4 weeks. The request can also indicate a time range of interest in the future. That is, the time range indicated in the request can span from the past through the present day, and into future dates. For example, the request can indicate that the user wants to see predicted segment sizes in daily increments going 3 weeks into the future. In response to receiving the request, control is passed to block 640.

At block 640, audience data is retrieved. As shown, this block can comprise translating request received at block 530 into queries for audience data and then executing the queries to obtain a time series of audience data. In one embodiment, Web server 432 can be used at block 640 to convert the audience segment indicated in the request into multiple queries (e.g., multiple queries to be executed by an in-memory database). In an additional or alternative embodiment, web server 432 can also be used at block 640 to concatenate all individual requests received at block 630 into the time series.

Next, at block 650, audience segment sizes over time are calculated based on the audience data retrieved at block 640. As illustrated in FIG. 6, block 650 can comprise estimating historic segment sizes and predicting future segment sizes over time increments (e.g., weeks, days, hours) across the time range indicated in the request received in block 630. For example, block 650 can include using the retrieved audience data to estimate segment sizes in daily increments going back in time one or more weeks in the past relative to the current day. Further, for example, block 650 can also include using the time series of the retrieved audience data from block 640 to predict daily segment sizes in daily increments going one or more weeks into the future. For instance, once slave cluster 434 (e.g., a Solr cluster) has the time series retrieved at block 640, a predictive algorithm can be applied to predict how the audience segment size will change in future time increments (e.g., weeks, days, hours).

The segment population size may indicate the number of unique visitors that qualify under a segment according to the segment rule. The segment population size may be performed for one or more time ranges. For example, the segment population size may be for the last 7 days, last 30 days, last 60 days, etc. Estimating the audience segment size (e.g., population) for historic time periods and time ranges may include evaluating the combined recency and frequency of each qualification event (e.g., including a time of occurrence associated with each respective qualification event) within the time periods and ranges of interest.

In one embodiment, estimating the segment population size may include executing a search query on a data store of the back end component that searches millions of visitor profiles (from first and third party data) nearly immediately. The search service may be referred to as a distributed search cluster service with the result being a real-time estimation of the segment population size. In some embodiments, the search service may be implemented as an Apache Solr cluster of the segment analysis module or a comparable open source search tool/platform of the segment analysis module. For example, all the visitor profiles and traits may be stored in a Solr cluster. Upon receiving an audience definition/segment rule (e.g., via a UI/portal), a query to search the Solr cluster may be executed. The Solr cluster may then return the number of visitors qualifying under the audience definition. Other embodiments may use a traditional database.

The segment population size for the time period (e.g., for one time period) and other respective segment population sizes (e.g., for other time periods) may be provided for display. The segment population size and each of the other respective segment population sizes may each correspond to a respective time range of a plurality of time ranges. Example displays of such segment population sizes are shown in FIGS. 8 and 14-18. The UI/portal may provide a calculate/recalculate segment population button or other input option. Upon selecting such a button or input option, one or more queries can be generated to the backend, as described herein, which may then return the segment size estimations for past time periods as well as segment size predictions for future time periods. If the segment rule is defined as three occurrences (e.g., qualification events) in the last seven days, then the segment size estimation over the last 30 days will correspond to qualification of visitors over any 7 consecutive day period in the last 30 days. For example, the last 30 days segment population may include a visitor who qualified based on data from days 1-7 and another visitor who qualified based on data from days 21-27. Similarly, segment size prediction going forward 30 days into the future can include a visitor who is predicted, based at least in part on patterns of past qualifications and behaviors, to qualify in any 7 consecutive day period in the next 30 days.

In one embodiment, future segment population sizes can be estimated based on the estimated segment population sizes. For example, the system may determine that the estimated segment population size has a trend of a 10% increase for each 60-day period. Therefore, the system may estimate that the future segment population size may continue to increase by 10% for subsequent 60-day periods.

After the audience segment sizes are calculated, control is passed to block 660.

In block 660, a report is generated that indicates the estimated historic segment sizes and predicted future segment sizes across the time range. The report generated in this step can be a bar chart graphically depicting daily estimated historic segment sizes in the past as well as daily predicted future segment sizes. Non-limiting examples of such reports are depicted in FIGS. 8A and 8B, which are described below. The time increment of the report can be varied to have a finer granularity (e.g., hourly) or a coarser granularity (e.g., weekly) in response to user input. For example, a report showing hour-by-hour estimated and predicted segment sizes may be useful for marketers who seek to present ads during peak time periods for a given segment (e.g., after 7 pm Pacific time when the segment includes visitors living in California). The report generated at block 660 can also be interactive. For example, a user may be able to scroll backwards into the past (e.g., to the left when time is represented along an x-axis of the report) to display additional segment size estimates for past time periods. Similarly, the report can allow the user to scroll forwards into the future (e.g., to the right when time is represented along the x-axis of the report) to display additional segment size predictions for future time periods. The near real-time features of the audience size estimation and prediction systems and methods described herein enable such navigation in the interactive report (i.e., scrolling into the past and future) without resulting in significant delays or lag time in rendering the report data.

The disclosed techniques may have the speed advantages of real-time segment qualification along with the data storage scale advantages of back end segment qualification. The back end segment qualification additionally permits qualification of visitors even without ever seeing that visitor again. Moreover, by using real-time qualification in conjunction with backend qualification, there may be less discrepancy rates as opposed to simply using real-time qualification and waiting for the visitor to stick around. Also, the disclosed techniques may facilitate qualifying visitors as members of audience segments in real-time and support near real-time audience segment size estimation. Additionally, the disclosed techniques may provide real-time feedback to a customer on segment population size as the segment rule is being defined, something that otherwise may not be achieved with a traditional relational database system.

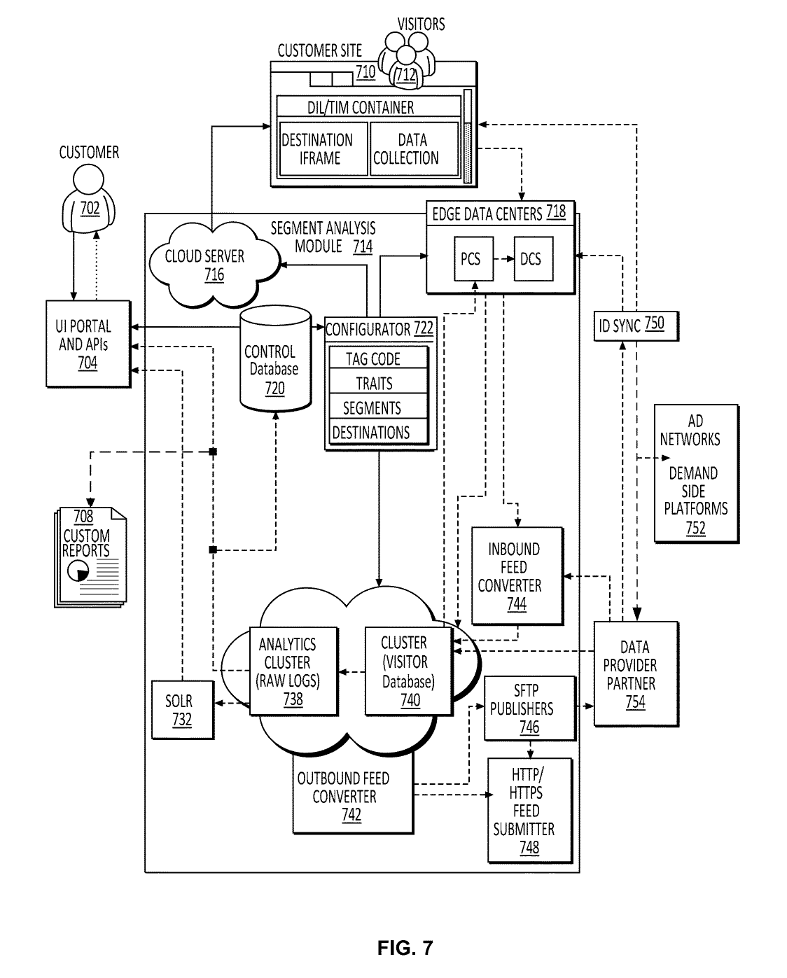

FIG. 7 illustrates an example block diagram of a system configured to implement the methods of FIGS. 5 and 6, in accordance with some embodiments. As shown, certain portions of FIG. 7 are similar to portions of FIGS. 2 and 3. For those portions, descriptions similar to that of FIGS. 2 and 3 applies to FIG. 7 but, for brevity, are not necessarily repeated. Solid lines between components of FIG. 7 represent customer driven data, dashed lines represent visitor driven data, and the dotted line to custom reports 708 represent reporting data. Beginning at the top of FIG. 7, visitors 712 may visitor a customer website 710. Customer website 710 may be presented in a browser application of a client device of visitor 712. A JavaScript library, such as, for example, a data integration library (DIL), hosted by the customer may be loaded, which may call an IFRAME that is hosted on a server (e.g., on an Akamai server) that may be used for real-time destinations (e.g., where to send a URL to get an ad).

Data about the visitor's visit and/or about the visitor may be collected through customer web site 710 and provided to edge data centers 718, which maintain the traits and segments. The DCS may store trait qualification activity to PCS, which may be a low latency edge cache database (e.g., implemented on top of a Not Only SQL/NoSQL database technology). The DCS may read times of trait qualifications of visitors from the PCS in real-time to determine segment qualification. Note that back end ingested trait data may also be stored at edge data centers 718 to take advantage of real-time speed with greater flexibility in segment qualification. Log files that include information about the visitor and what the visitor did during the visit may then be sent to cluster (visitor database) 740, which is implemented in the cloud in the illustrated embodiment. Sending of the log files may be periodic (e.g., every 10 minutes). Cluster (visitor database) 740 may store a large number of visitor profiles (e.g., more than 7 billion). Once that data is written to cluster (visitor database) 740, which may be part of the back end component, it may be written out to analytics cluster (raw logs) 738. Analytics cluster (raw logs) 738 allows for an association between visitor and trait. Periodically (e.g., once a day, twice a day, etc.), analytics cluster 738 may then write its stored data to Solr 732 to update the Solr indexes. That data may include a trait/time combination for each visitor for each qualification event. Estimates of segment size may then be performed according to the techniques disclosed herein. Such estimates may be provided as custom reports 708 and/or as data for display at UI portal and APIs 704 for customer 702.

From the viewpoint of customer 702, UI Portal and APIs 704 may call a customer application programming interface (API) that interacts with a cluster, such as, for example, a Solr cluster, to generate queries on the dataset and return results and a confidence interval based on the data set result size. This can result in customer 702 receiving nearly instantaneous feedback, even while creating and using extremely complex segments. For example, customer 702 may define an audience segment rule by inputting visitor traits, destination rules, and/or Routing Information Field (RIF) operators, among other inputs. That rule is stored and persisted in control database 720. Via configurator 722, tag code, visitor traits, audience segments, and destinations can be shared between the real-time component (including edge data centers 718) and the back end component (including cluster 740 and analytics cluster 738). TIM Tags, Destination Publishing, and Data Collection Scripts may then be pushed through a cloud-based server 716 to the DIL/TIM container of customer site 710. The destination IFRAME may be used for performing ID sync calls via ID sync 750. For example, the destination IFRAME may be used when trying to match a visitor ID with an ID from third party data for server-to-server file transfers. The IFRAME is a separate frame that can have a different source from the current domain that the visitor's browser is in. The IFRAME may be hidden from the visitor such that the visitor never sees it. Therefore, data transfers and data synchronization may be performed without affecting the end user/visitor. Additionally, the IFRAME is boxed off from a security standpoint. Whatever happens in the IFRAME cannot affect the customer domain. Using the IFRAME and the call to the DCS, a URL destination can be sent to send information to a third party.

Data provider partner 754 represents a third party data provider. Third party data may be matched to other data via ID sync 750. Third party data (and first party data from edge data centers 718) may be processed by inbound feed converter 744 before being stored in the backend (e.g., cluster 740). Outbound feed converter 742 of the back end component may likewise process data from the backend before sending it to SFTP publishers 746 and HTTP/HTTPS feed submitter 748. Such data from the back end may be provided to data provider partner 754.

As shown in the right side of FIG. 7, an instruction may be provided to ad networks/demand side platforms 752 indicative of a visitor's segment qualification and/or indicative of an ad to present for display to that visitor.

### Exemplary User Interfaces and Reports

FIGS. 8A, 8B, and 9-20 illustrate exemplary user interfaces (UIs), reports, and graphs according to embodiments of the present disclosure. The UIs, reports, and graphs depicted in FIGS. 8A, 8B, and 9-20 are described with reference to the embodiments of FIGS. 1-7. However, the reports, UIs, and graphs are not limited to those example embodiments.

In FIGS. 8A, 8B, and 9-20, displays are shown with various icons, command regions, windows, slider controls, toolbars, menus, and buttons that are used to initiate action, invoke routines, request segment size estimates, create segments, select visitor traits, display segment statistics, or invoke other functionality. The initiated actions include, but are not limited to, creating segments, selecting visitor traits, requesting segment size estimates over time, and segment data management related inputs. For brevity, only the differences occurring within the figures, as compared to previous or subsequent ones of the figures, are described below.

In one or more embodiments, the user interfaces and reports shown in FIGS. 8A, 8B, and 9-20 may be displayed via the display interface 2102 and the computer display 2130 described below with reference to FIG. 21. In certain embodiments, the UIs can be configured to be displayed on a touch screen display device. According to embodiments, a publisher 112, advertiser 102, and/or sales person can interact with the UIs shown in FIGS. 8A, 8B, and 9-20 using input devices such as, but not limited to, a stylus, a finger, a mouse, a track pad, a keyboard, a keypad, a joy stick, a voice activated control system, or other input devices used to provide interaction between a user and the UIs and reports. As described below with reference to FIGS. 8A, 8B, and 9-20, such interaction can be used to define, modify, and/or select an audience segment and to request and display size estimates for a selected segment.

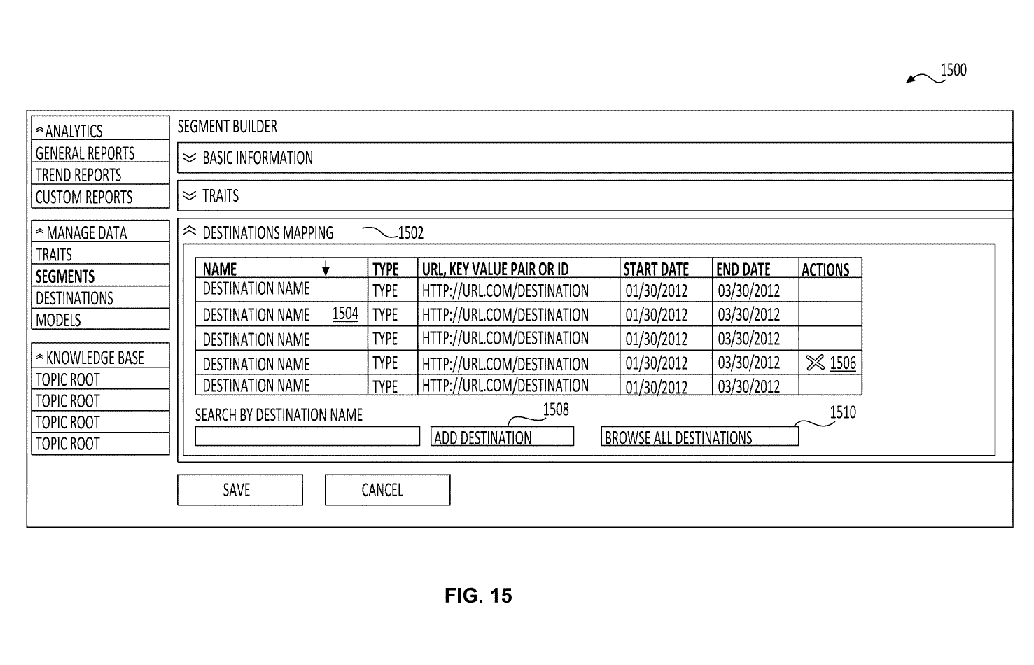

FIG. 8A illustrates an user interface 800 that can be used to produce a segment size graph 814 that indicates estimated sizes of an audience segment. As shown, the audience segment can be selected from all segments 806 which can be hierarchically listed in a segment builder 802. In the example of FIG. 8A, basic information 804 is displayed for a selected ‘young men in San Jose’ segment′ within segment builder 802. In particular, FIG. 8A shows a UI with an audience size estimates and prediction graph 814. As shown, graph 814, labelled ‘Estimated Historic Segment Size,’ includes estimates of past, historic audience segment sizes along with predicted future segment sizes for the ‘young men in San Jose’ segment. In the example of FIG. 8A, as a marketer creates the segment by using a basic view 810 within segment builder 802 to specify visitor traits 828 of genderMale and age18to25 and citySanJose, they can see graph 814 of the number of people/visitors in that segment over time. Additional traits can be selected by using the add trait button 812. By viewing graph 814, marketers can also see the predicted change in the number of people in the segment in the future. The system, architecture, and methods described above with reference to FIGS. 1-7 can calculate graph 814 in real-time. For example, in response to receiving a selection of recalculate button 816, the estimates and predictions in graph 814 can be re-calculated in near real-time. By selecting destinations mapping 818 in UI 800, a Destinations Mapping tab can be expanded. An example Destination Mapping 1502 for a segment builder application is shown in FIG. 15, which is described in detail below.

FIG. 8B illustrates a user interface 840 that can be used to produce a segment size graph 814 that indicates multiple, estimated sizes of an audience segment. As shown, the multiple, estimated segment sizes can be based on multiple algorithms 830. In the non-limiting example of FIG. 8B, algorithms 830 include linear regression, multiplicative with weekly seasonality, and multiplicative with annual seasonality. In additional or alternative embodiments, algorithms 830 and techniques for predicting audience segment sizes displayed in interface 840 can include polynomial regression, multiplicative/additive decomposition, linear trend with multiplicative additive seasonality, wavelet forecasting, Fourier transforms, and neural networks. FIG. 8B shows how graph 814 can include a dialog baloon 832 indicating a particular estimated segment size for a given date in the future (e.g., 20,583 visitors on Nov. 28, 2014). Dialog 832 can be displayed in response to a selection of a future day and a particular algorithm's plot within graph 814. Selection can be made by hovering (e.g., with an indicator of a mouse, a stylus, a finger, or another pointing device) over a point in the plot of an algorithm in graph 814. Dialog 832 may be displayed upon hover over and may include information such as the predicted segment size and the date. In one embodiment, dialog 832 is displayed in response to detecting that a user is hovering over a particular date in a graph corresponding to one of the algorithms 830. In the example of FIG. 8B, dialog 832 is displayed with information corresponding to a multiplicative with annual seasonality algorithm in response to detecting a selection of that algorithm's plot. FIG. 8B shows that UI 840 includes a prediction graph 814 with multiple audience size estimates. In the example of FIG. 8B, the multiple estimates are line graphs based on respective ones of a plurality of algorithms 830. As shown, graph 814, labelled ‘Estimated Historic Segment Size,’ includes actual past, historic audience segment sizes along with predicted future segment sizes for the ‘young men in San Jose’ segment. By viewing graph 814, marketers can also see the predicted changes in the number of people in the segment in the future, based on one or more of the algorithms 830. The system, architecture, and methods described above with reference to FIGS. 1-7 can calculate graph 814 using algorithms 830 in real-time. For example, in response to receiving a selection of recalculate button 816, the multiple estimates and predictions in graph 814 can be re-calculated in near real-time. One or more of the algorithms 830 can be removed from graph 814 by selecting a delete icon (e.g., an ‘x’) that is displayed next to the algorithm name. Similarly, by selecting the ‘add algorithm’ button shown in FIG. 8B, an additional algorithm 830 can be selected for inclusion in graph 814.

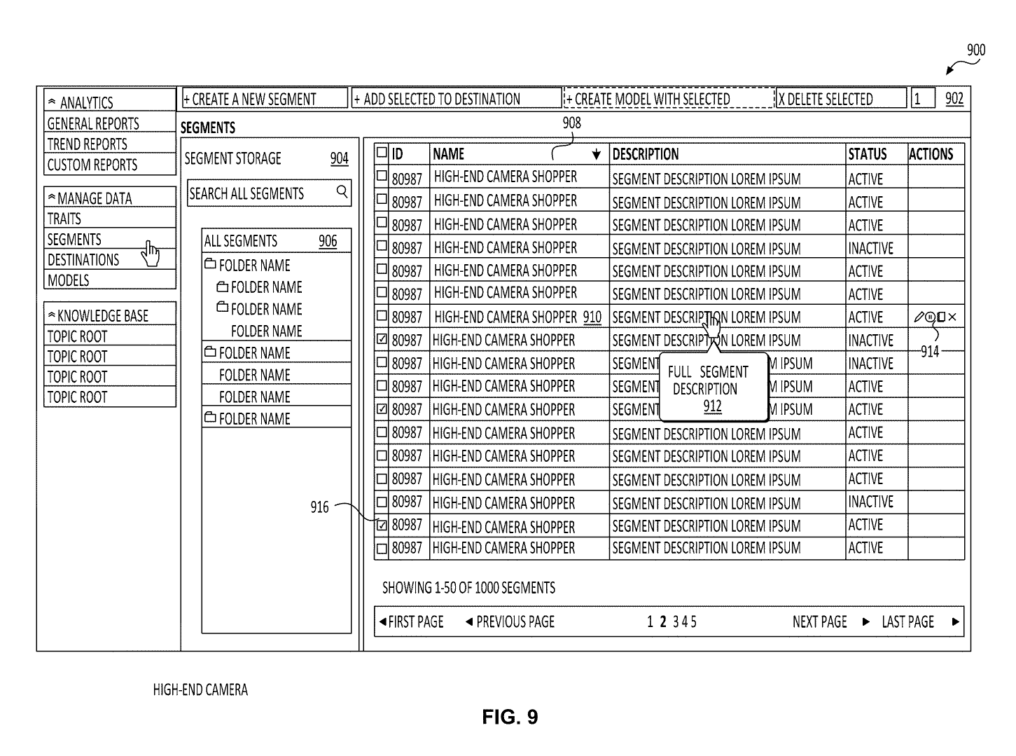

FIG. 9 illustrates interface 900 for managing various segments according to a list view. Context-specific tool bar 902 of interface 900 may present a variety of context-specific actions. For example, Create a New Segment, Add Selected to Destination, Create Model with Selected, Delete Selected, are among other possible actions may be presented in context-specific tool bar 902. Some actions may appear based on specific interactions. For example, Create Model with Selected may only appear after selection of a segment. Search 904 permits segment-specific searches to be performed. The search/filter element may be specific to searching segments. Entering a character in the search input may immediately filter the segment list to segments that contain the term or sequence of characters. Folder browser 906 allows users to navigate folders and/or sub-folders that contain segments. Folders that contain children can be toggled open by clicking the folder icon. Activating a folder filter may activate a segment list view, an example of which is shown in FIG. 9, to display the segments contained within the selected folder. The list of segments 908 may be sortable, filterable, and/or include tabular data. Segment elements may be sorted, for example, by clicking the table header of the column. Segment hyperlinks 910 may be selectable (e.g., via mouse click, touchscreen, or other selection) to take the user to a segment detail page/summary. Segment description 912 may appear in a bubble, as shown, when hovering (e.g., with an indicator of a mouse) over the segment row. Segment actions 914 may be displayed upon hover over and may include actions such as edit segment, pause/activate segment, clone segment, and/or remove segment, among others. Hovering over an action icon may cause display of a tool tip describing the action. Segment selection 916 may permit users to select segments, for example using checkbox elements, to remove the selected segments from the list view.

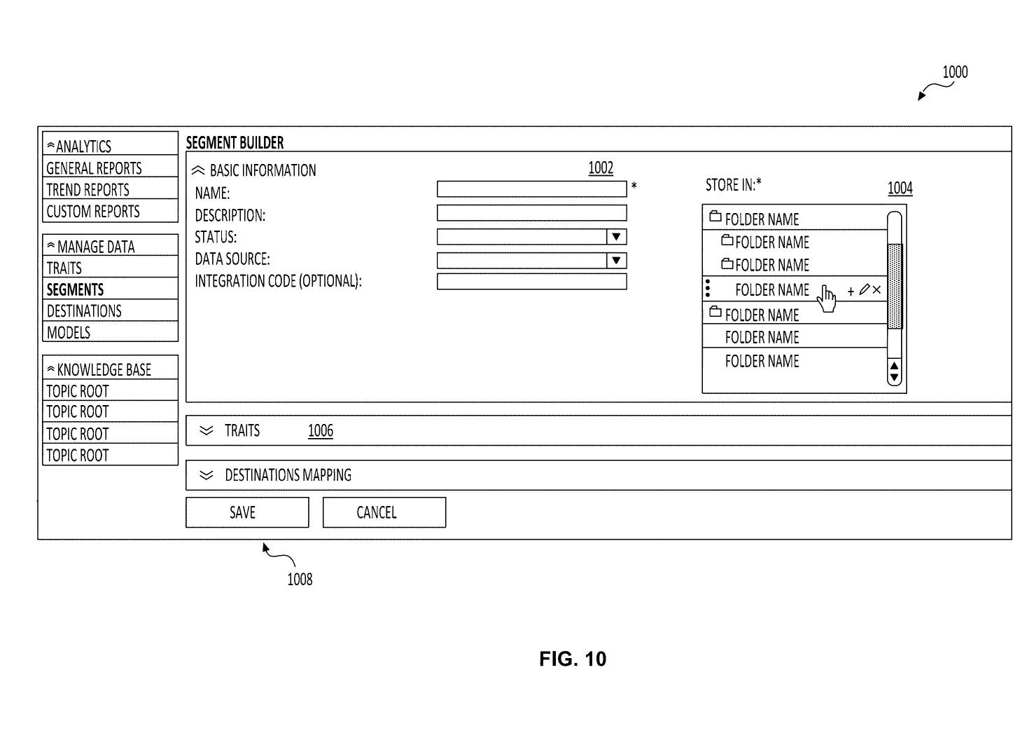

FIG. 10 shows a snapshot of an example display 1000 of the basic information options for creation of a new segment. Basic information tab 1002 may be open by default. Segment storage 1004 may permit users to select a folder to store a new segment. FIG. 10 illustrates collapsed/minimized tabs 1006 for both the Traits and Destinations Mapping tabs. The collapsed tabs may be expanded and likewise, expanded tabs (e.g., basic information tab 1002) may be collapsed. Expanding/collapsing may be toggled, in one embodiment, via selection of the double carrot to the left of the tab name. Save/cancel 1008 may be selected in FIG. 10 to apply any previous input(s), such as segment name, description, status, data source, integration code, etc. as shown in basic information tab 1002.

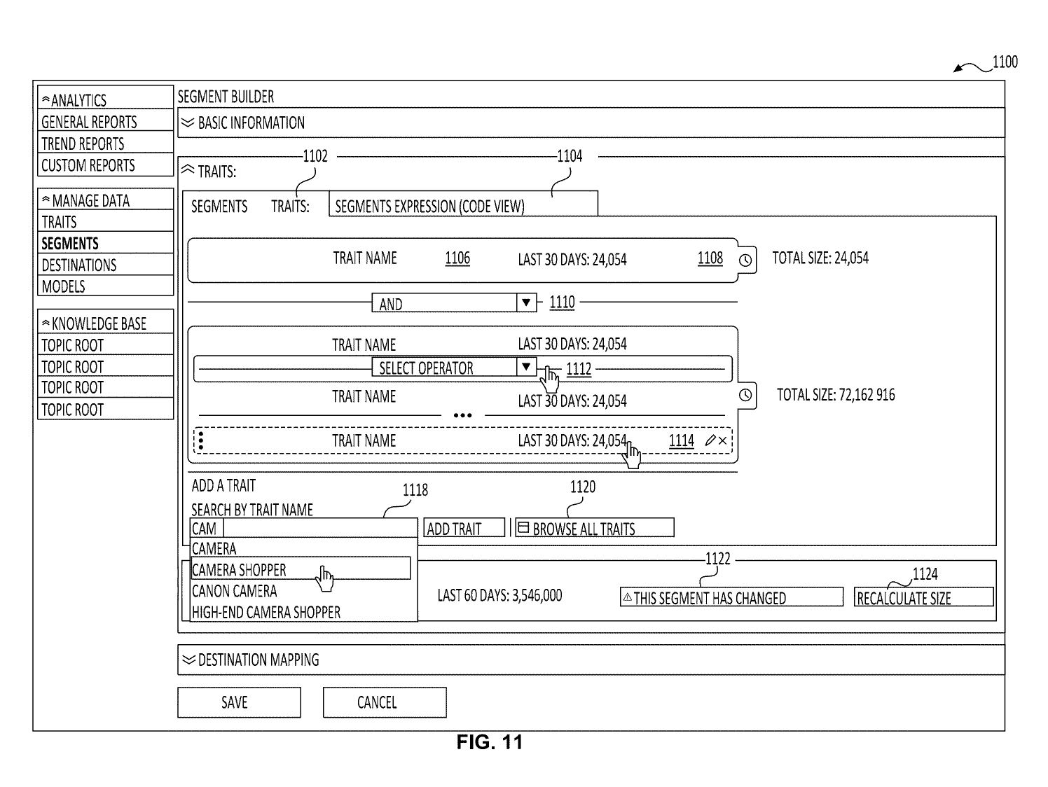

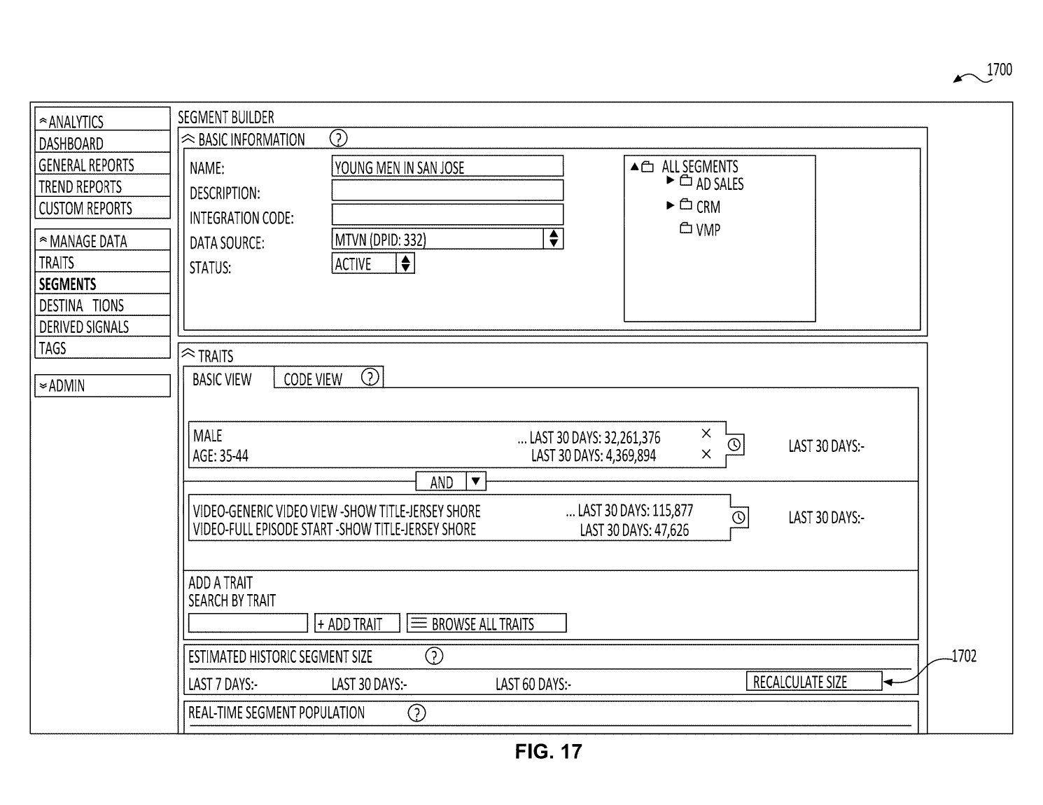

FIG. 11 shows a snapshot of an example display 1100 of the expanded trait tab, which may be used to create a new segment. The default active tab 1102 may be a what-you-see-is-what-you-get (WYSIWYG) view. Code view tab 1104 may permit a user to see the code that is generated from the WYSIWYG view and or permit a user to define a segment and/or traits using a code view. For example, a user may also simply type or otherwise input a code expression into the segment expression code view. An example of the code view is shown in FIG. 17. Displayed trait 1106 may be composed of a hyperlinked trait name and the last 30-day unique visitors (e.g., 24,054 in the example shown). Clicking a trait hyperlink may open a modal window, or other display, that displays read-only basic information regarding the trait. Such a display that displays read-only basic information regarding the trait is shown in FIG. 11. Added traits may be automatically grouped together but can be separated by operators (e.g., Boolean operators). Icon 1108 (shown as a clock symbol) may indicate if recency and frequency rules have been added to a trait or a group of traits. Selection of icon 1108 may permit the frequency and/or recency rule to be modified. Operators 1110 may allow traits or groups to be separate by operators such as AND, OR, AND NOT, and/or OR NOT. Hovering between two traits may display operator selection interface 1112. Selecting an operator may separate the traits or groups of traits. Hovering over a trait may expose trait tools 1114, such as edit, remove, and/or drag-and-drop tools. As one example, a trait may be dragged vertically into the desired position according to the drag-and-drop tool. As another example, a trait may be edited by clicking the edit icon or a trait may be removed from the list by clicking the remove icon. Total size 1116 may be calculated as the sum of the 30-day unique visitors of all of the traits in a group. Add trait 1118 permits input to enter a rule into the interface. Entering text in the Search by Trait Name field of add trait 1118 pane may display existing traits that can be selected and added to the segment. As shown, the user in this example is searching for “Cam” with results being “Camera”, “Camera Shopper”, “Canon Camera” and “High-End Camera Shopper.” New traits can be added to the bottom of the other traits that are already shown and can be automatically grouped with the last trait in the list. User interface 1100 may provide indication 1122 that is indicative of a changed segment. Such an indication may prompt a user to select the Recalculate Size button 1124 to recalculate the size of an audience segment. The example UI of FIG. 11 can receive a selection of a Browse All Traits button 1120, and in response to the selection, display a modal interface containing a filterable, searchable list of traits 1102, as shown in FIG. 11.

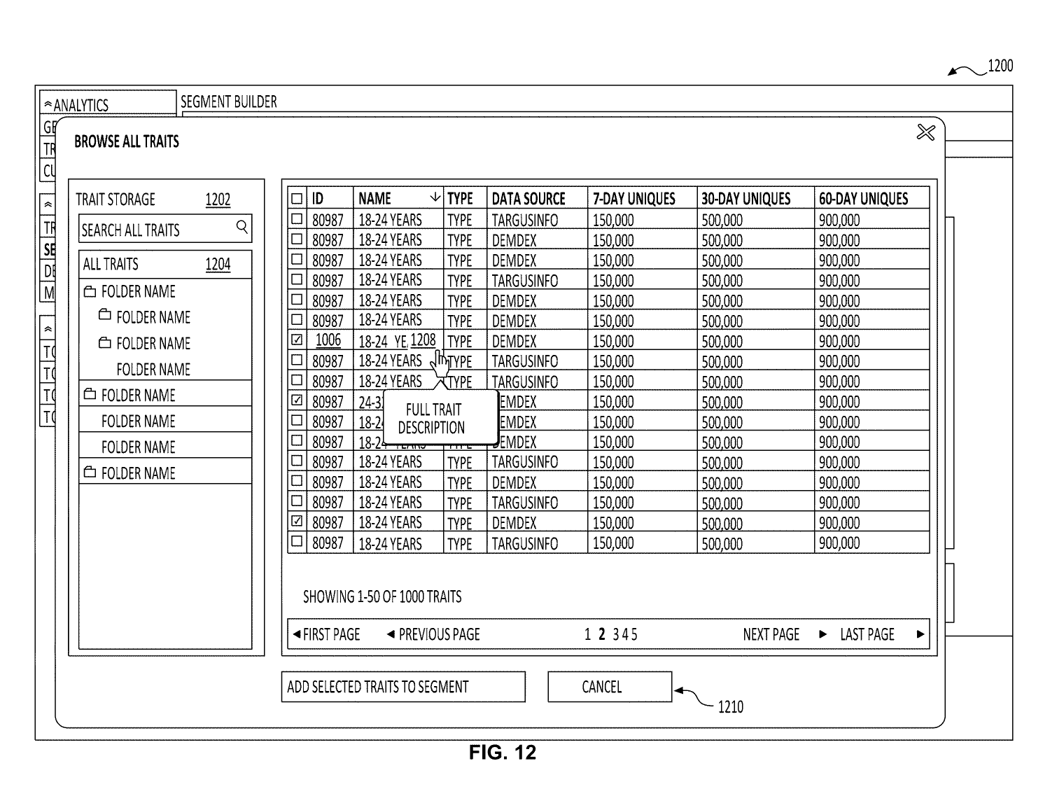

FIG. 12 illustrates an example of the modal interface upon selection of Browse All Traits 1120 of FIG. 11. Trait-specific search 1202 is a search/filter element specific to visitor traits. Entering a character in the search input may filter the trait list to visitor traits that contain the term or sequence of characters. Folder browser 1204 permits navigation of folders and sub-folders that contain traits. Folders containing children can be toggled open by clicking the folder icon. Activating a folder may cause the trait list view to display the traits contained within the selected folder. Visitor trait selection 1206 is indicated by the checkbox next to a given visitor trait. Visitor traits may be selected by clicking anywhere on the trait row and is not limited to the actual checkbox. In some embodiments, trait data 1208 may not permit trait name hyperlinks or trait actions in the model interface of FIG. 12. Action buttons 1210 may permit selected traits to be added to a segment by clicking Add Selected Traits to Segment. Clicking Cancel closes the interface, ignoring whatever selections were made, and returns the user to the segment builder display of FIGS. 9-11.

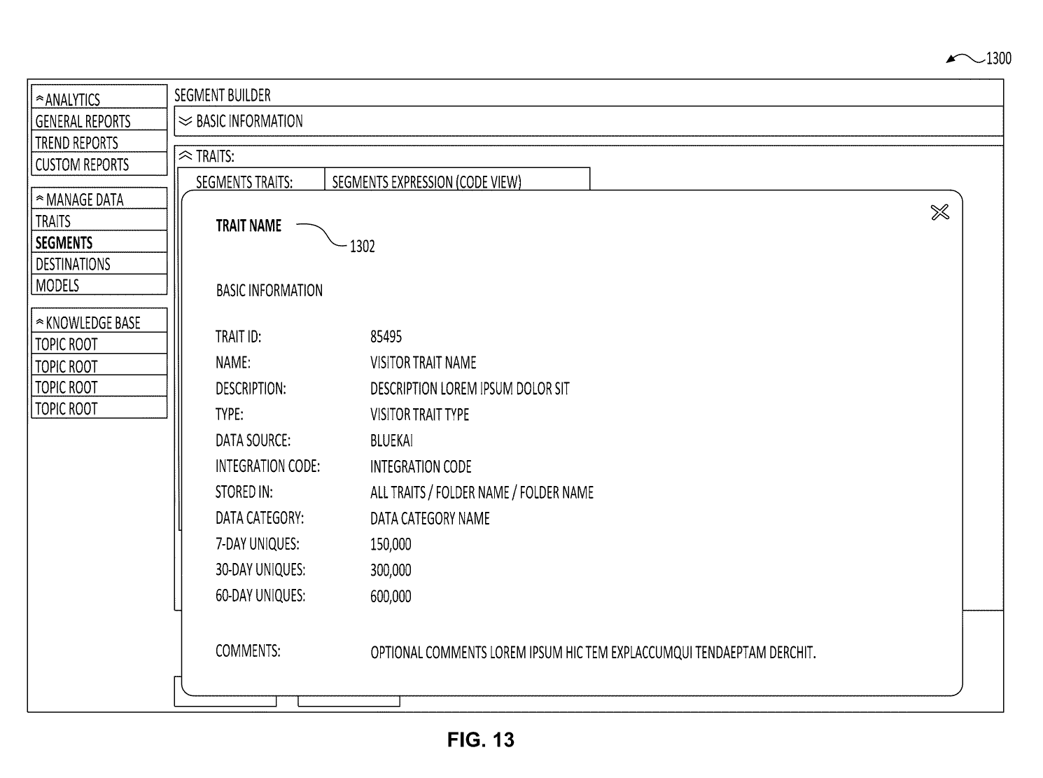

In response to receiving a selection of a hyperlinked visitor trait name in segment builder 902 (e.g., visitor trait name 910 of FIG. 9), modal interface 1300 shown in FIG. 13 can be displayed. Modal interface 1300 displays read-only, basic information for the selected trait with name 1302. The display of the information is read-only in that no actions may be taken regarding the trait or segment in from the interface of FIG. 13. As shown, various information may be presented in the interface of FIG. 13 including a visitor trait ID (e.g., 85495), name (e.g., Trait Name), description, type, data source, integration code, stored location, data category, unique visitors for various time ranges (e.g., 7-day, 30-day, 60-day, etc.), and/or comments regarding the visitor trait.

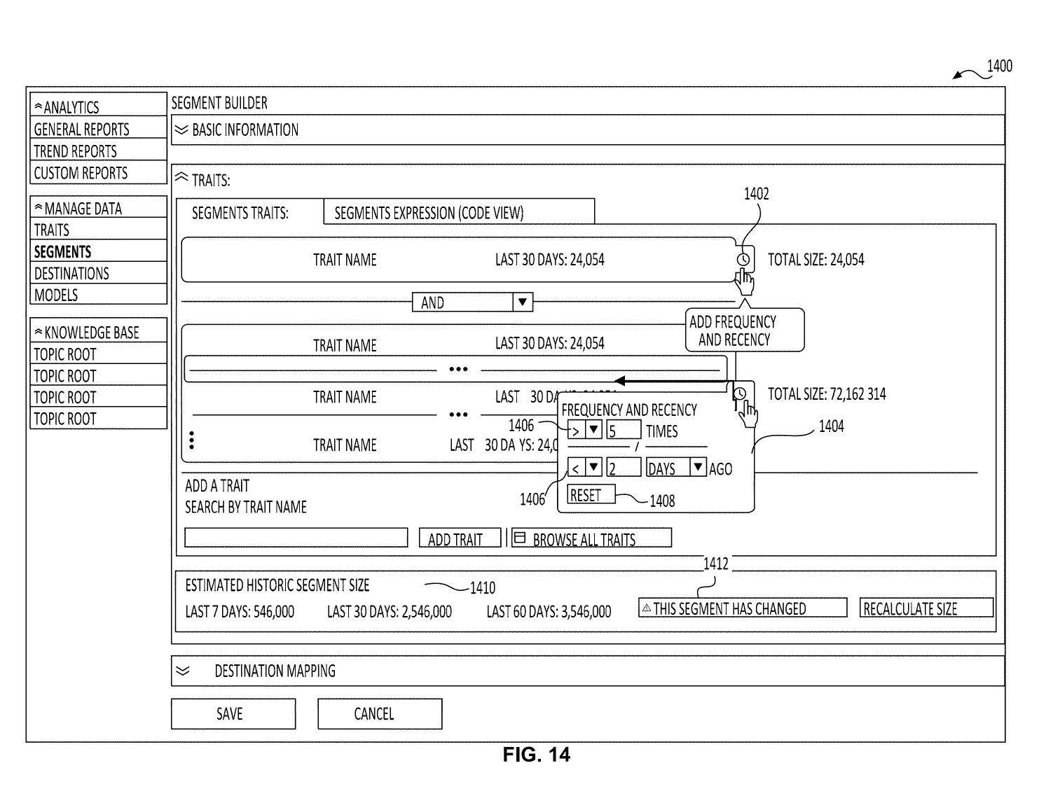

As shown in example interface 1400 of FIG. 14, in response to receiving a selection of the recency-frequency icon 1402 for a given visitor trait or group of visitor traits, a recency frequency interface 1404 can partially overlay the selected trait or group of traits for which the recency frequency operator is to be applied. As shown, recency frequency selectors 1406 in recency frequency interface 1404 can include frequency operators, numbers, and/or time selectors (e.g., hours, days, weeks, etc.). As illustrated in the example of FIG. 14, a frequency of greater than 5 times within the past 2 days can be indicated using recency frequency selectors 1406. Action buttons 1408 may include a reset button that may reset the recency and frequency interface settings to a default setting. Other action buttons (not shown) may include a save button within recency frequency interface 1404 (in addition to the Save/Cancel buttons at the bottom of interface 1400). Estimated historic segment size 1410 can be displayed below the visitor trait list. If a change is made to a segment, notification 1412 can be displayed. In the non-limiting example of FIG. 14, notification 1412 includes a message indicating “This segment has changed” along with an action button to Recalculate Size.

FIG. 15 shows example interface 1500 that illustrates expansion of the Destinations Mapping tab 1502 for an example segment builder application. The destinations are displayed in table format in the illustrated example. In various embodiments, destinations may include a URL, key value pair, and/or ID, as well as a start and end date. Destination name 1504 may be a selectable hyperlink that, upon selection, opens a modal interface containing read-only basic information about the destination. Actions 1506 and 1508 permit a destination to be removed from or added to a segment. Browse All Destinations 1510 is selectable to open a modal interface that includes a list of destinations.

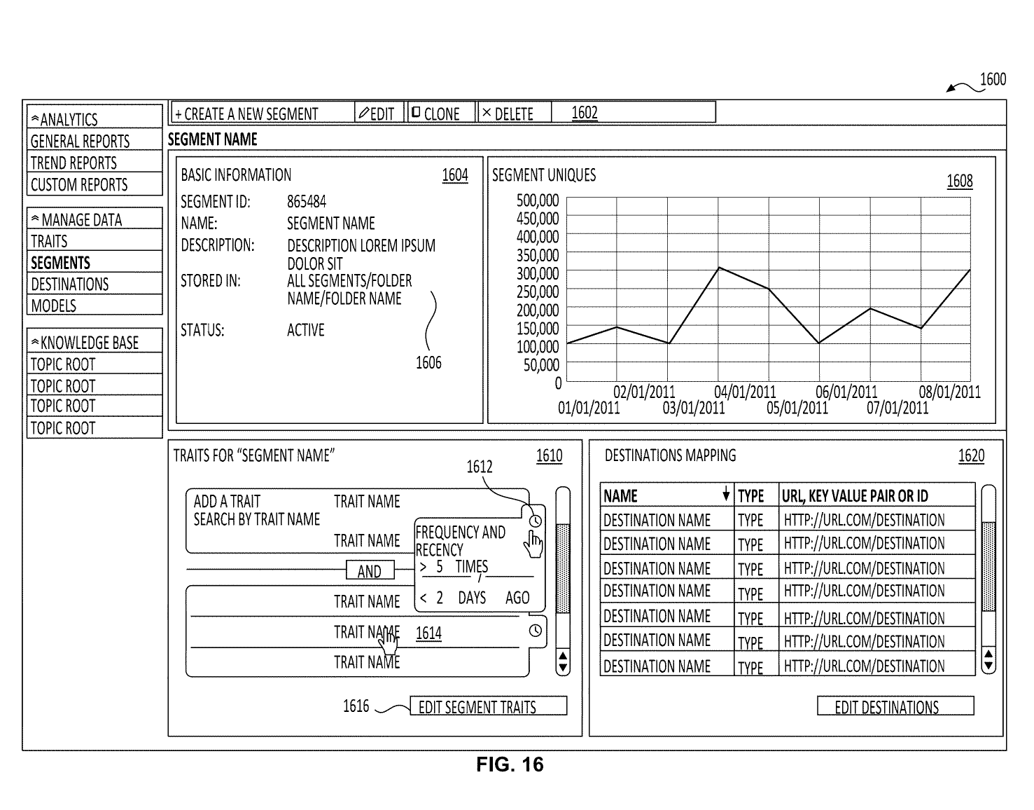

FIG. 16 illustrates a summary view of an audience segment. Toolbar options 1602 may include Create a New Segment, Edit Segment, Clone Segment, Delete Segment, and/or Share/Print. Basic information entered during segment creation may be displayed in the basic information panel 1604, which may include read-only segment storage path 1606. The summary view may also include a graphical display 1608 that illustrates the number of unique segment visitors at various times (which may represent various length time intervals, such as a 7-day, 30-day, 60-day, etc. time interval). The traits and operators that are used to create the segment may be displayed in trait panel 1610. Trait panel 1610 may include icon 1612 that indicates if recency and frequency rules have been added to a trait or a group of traits. Hovering over icon 1612 (e.g., as shown by the finger pointer in FIG. 16) may display a read-only (e.g., not editable within trait panel 1610) summary of the recency-frequency. Selecting a trait name 1614 may take the user to the trait summary interface. Segment traits may be edited by selecting button 1616, which may redirect the user directly to the traits edit interface. Destinations 1620 can be displayed and can be edited by selecting Edit Destinations.

FIGS. 17-19 illustrate an example creation of a segment and use of the created segment, according to various embodiments. As shown in FIG. 17, an example interface 1700 is shown, which illustrates the basic information and trait tabs expanded. The segment in the example is named Young Men in San Jose, is selected as an active segment, with a data source chosen. Data sources may include real-time data sources, offline data sources (e.g., first party offline data, or data from third party data providers), and/or other data sources. As shown, the segment rule includes AND′ing together the traits Male and age 18-25 with the traits Video-Generic Video View-Show Title-Jersey Shore and Video-Full Episode Start-Show Title-Jersey Shore. In FIG. 17, because the segment is being created, the size of the segment has not yet been calculated. As shown, a Recalculate Size button 1702 can be selected to estimate and/or calculate the audience size of unique visitors that qualify according to the segment rule that is created. In response to receiving a selection of Recalculate Size button 1702, historic audience segment sizes for various time periods (e.g., last 7 days, 30 days, 60 days) can be estimated in near real-time. According to an embodiment, the UI 800 described above with reference to FIG. 8 can be displayed when the Recalculate Size button 1702 is selected. For example, after a segment rule is created and the Recalculate Size button 1702 is selected, the segment size graph 814 that includes both past, estimated historic sizes and predicted, future segment sizes can be rendered.

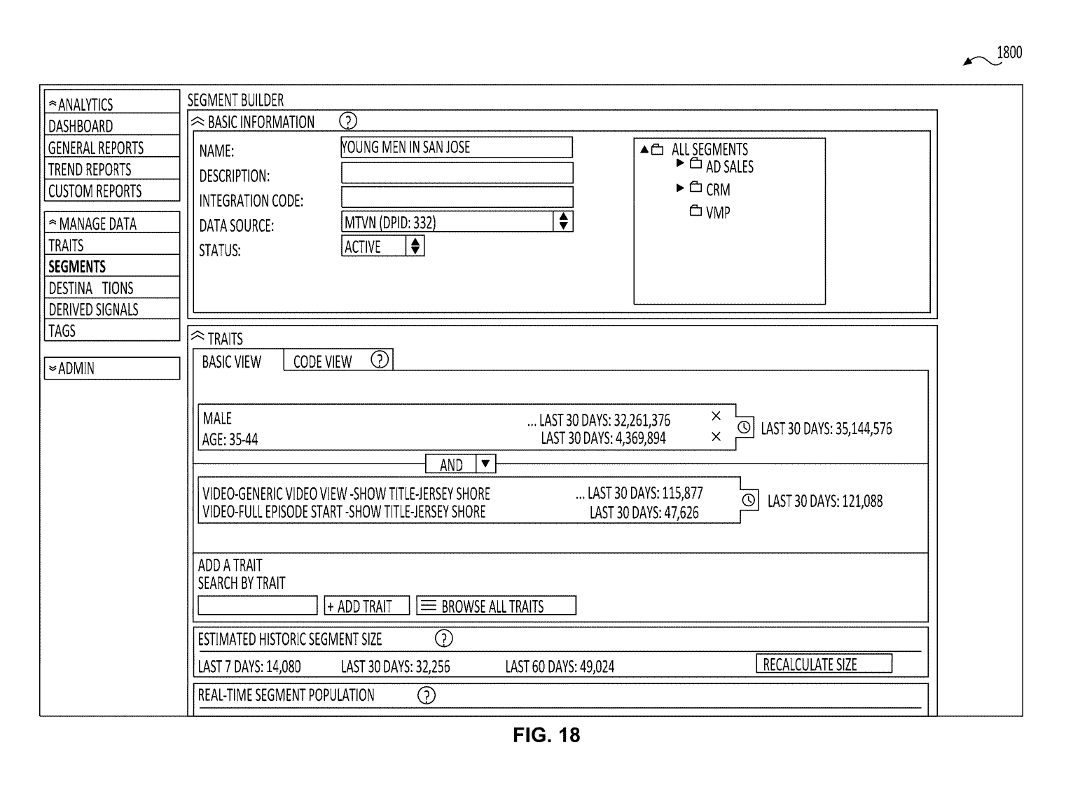

FIG. 18 continues upon the example of FIG. 15 and illustrates the calculation of the audience size as shown in example interface 1800. As shown, the last 30 days of unique visitors that qualify for each of the traits is shown as well as the estimated historic segment size for the last 7, 30, and 60 days. Note that in other embodiments, other time ranges may be displayed in addition to, or instead of, the example time ranges shown in FIG. 18.

FIG. 19 illustrates an example of using code view of interface 1900 to define a trait and/or segment, as opposed to the basic view shown in FIG. 15. As shown in FIG. 19, code view 1902 illustrates a segment definition using various terms and Boolean operators to define various traits. The example segment rule (61405T OR 62727T) AND (67874T OR 71056T) AND NOT (61404T OR 61794T OR (62726T AND 63562T)) is a segment rule defined according to a code view representation. Such a segment rule may represent an equivalent to the rule shown in FIG. 15 or it may be a completely different rule. Toggling between the basic view and code view 1902 can toggle the display of the trait and segment rule such that the when basic view is selected, a plain English representation of the segment rule represented by code view 1902 is displayed. For a segment rule defined in the basic view, receiving a selection of code view, will cause the segment rule to be displayed according to the code view. As shown, the code view can include a validate expression button 1904 that is usable to compile and/or otherwise validate that the segment rule and traits are valid. Save/cancel buttons 1906 are usable to save/cancel changes made to the segment rule while in the code view. If the validate expression 1904 button is selected, the segment rule is validated. If the segment rule is validated successfully, the rule can be automatically saved. The other portions of interface 1900 may function in a similar manner as the interfaces described above with reference to FIGS. 17 and 18.

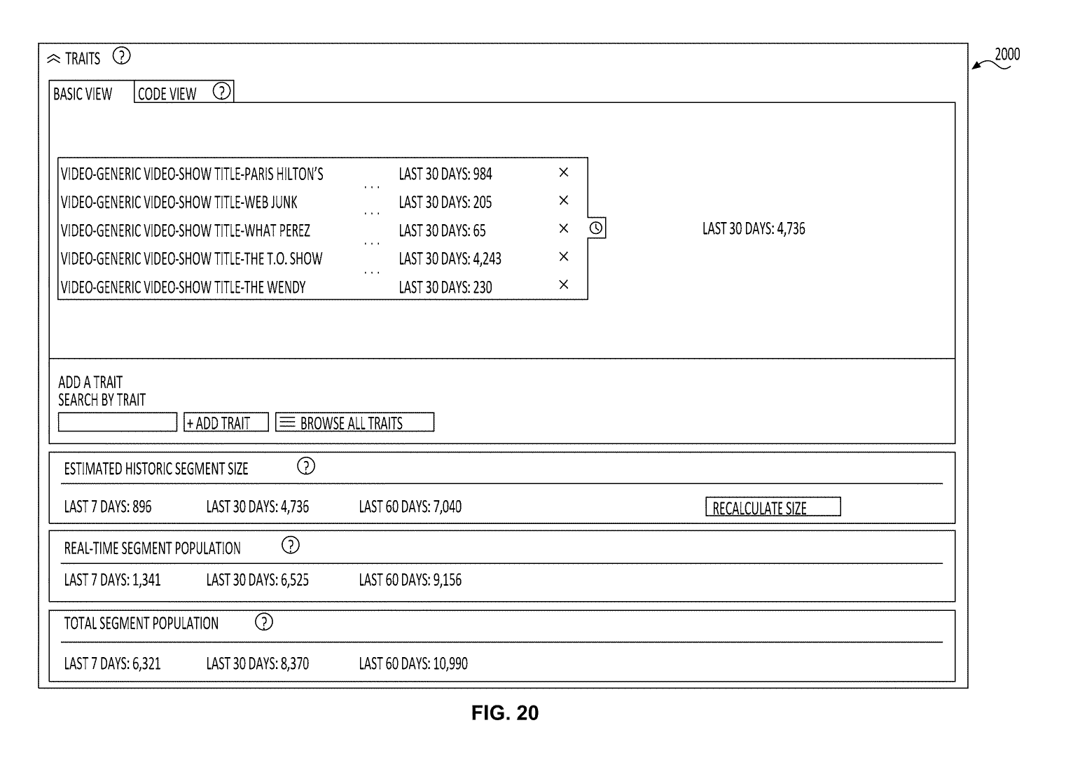

FIG. 20 illustrates one embodiment of an interface 2000 configured to display real-time and total segment population numbers for a segment rule that includes by one or more traits. As shown, the estimated historic segment size over the last 30 days indicates 4736 unique visitors that qualify for the segment whereas the real-time segment population indicates 6525 unique visitors over the last 30 days. The total segment population is 8370 unique visitors over the last 30 days. As shown in the example, numbers for the last 7 days and last 60 days are also displayed. Note that in other embodiments, other time ranges may be displayed in addition to, or instead of, the example time ranges shown in FIG. 20. Note that the total segment population minus the real-time segment population yields the number of visitors qualified via the back end component.

Exemplary Computer System Implementation

Although exemplary embodiments have been described in terms of apparatuses, systems, services, and methods, it is contemplated that certain functionality described herein may be implemented in software on microprocessors, such as a microprocessor chip included in computing devices such as the computer system 2100 illustrated in FIG. 21. In various embodiments, one or more of the functions of the various components may be implemented in software that controls a computing device, such as computer system 2100, which is described below with reference to FIG. 21.

Embodiments of a segment analysis module and/or of the various disclosed techniques described herein may be executed on one or more computer systems, which may interact with various other devices. One such computer system is illustrated by FIG. 21.

In different embodiments, computer system 2100 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, one or more servers, a peripheral device such as a switch, modem, router, or in general any type of computing or electronic device.

To implement the various features and functions described above, some or all elements of the computing devices, platforms, databases (e.g., databases 222 and 313 of FIGS. 2 and 3), and servers (e.g., servers 116, 122, 214, 216, 320, 326, 432 of FIGS. 1-4) may be implemented using elements of the computer system of FIG. 21. More particularly, FIG. 21 illustrates an example computer system 2100 for implementing the techniques in accordance with the present disclosure.

Aspects of the present invention shown in FIGS. 1-8, or any part(s) or function(s) thereof, may be implemented using hardware, software modules, firmware, tangible computer readable media having logic or instructions stored thereon, or a combination thereof and may be implemented in one or more computer systems or other processing systems.

FIG. 21 illustrates an example computer system 2100 in which embodiments of the present invention, or portions thereof, may be implemented as computer-readable instructions or code. For example, some functionality performed by the computing devices and servers 116, 122, 214, 216, 320, 326, 432 shown in FIGS. 1-4 can be implemented in the computer system 2100 using hardware, software, firmware, non-transitory computer readable media having instructions stored thereon, or a combination thereof and may be implemented in one or more computer systems or other processing systems. Hardware, software, or any combination of such may embody certain modules and components used to implement blocks and steps in the flowcharts illustrated by FIGS. 5 and 6 discussed above. Similarly, hardware, software, or any combination of such may embody certain modules and components of FIGS. 2-3 and 7 discussed above.

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the invention are described in terms of this example computer system 2100. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Processor device 2104 may be a special purpose or a general purpose processor device. As will be appreciated by persons skilled in the relevant art, processor device 2104 may also be a single processor in a multi-core/multiprocessor system, such system operating alone, or in a cluster of computing devices operating in a cluster or server farm. Processor device 2104 is connected to a communication infrastructure 2106, for example, a bus, message queue, network, or multi-core message-passing scheme. In certain embodiments, a processor of one or more of the computing devices, platforms, and servers 116, 122, 214, 216, 320, 326, 432 described above with reference to FIGS. 1-4 can be embodied as the processor device 2104 shown in FIG. 21.

Computer system 2100 also includes a main memory 2108, for example, random access memory (RAM), and may also include a secondary memory 2110. Secondary memory 2110 may include, for example, a hard disk drive 2112, removable storage drive 2114. Removable storage drive 2114 may comprise a floppy disk drive, a magnetic tape drive, an optical disk drive, a flash memory, or the like. In non-limiting embodiments, one or more of the memories of the computing devices, platforms, and servers 116, 122, 214, 216, 320, 326, 432 of FIGS. 1-4 can be embodied as the main memory 2108 shown in FIG. 21.

The removable storage drive 2114 reads from and/or writes to a removable storage unit 2118 in a well known manner. Removable storage unit 2118 may comprise a floppy disk, magnetic tape, optical disk, etc. which is read by and written to by removable storage drive 2114. As will be appreciated by persons skilled in the relevant art, removable storage unit 2118 includes a non-transitory computer readable storage medium having stored therein computer software and/or data.

In alternative implementations, secondary memory 2110 may include other similar means for allowing computer programs or other instructions to be loaded into computer system 2100. Such means may include, for example, a removable storage unit 2122 and an interface 2120. Examples of such means may include a program cartridge and cartridge interface (such as that found in video game devices), a removable memory chip (such as an EPROM, or EEPROM) and associated socket, and other removable storage units 2122 and interfaces 2120 which allow software and data to be transferred from the removable storage unit 2122 to computer system 2100.

Computer system 2100 may also include a communications interface 2124. Communications interface 2124 allows software and data to be transferred between computer system 2100 and external devices. Communications interface 2124 may include a modem, a network interface (such as an Ethernet card), a communications port, a PCMCIA slot and card, or the like. Software and data transferred via communications interface 2124 may be in the form of signals, which may be electronic, electromagnetic, optical, or other signals capable of being received by communications interface 2124. These signals may be provided to communications interface 2124 via a communications path 2126. Communications path 2126 carries signals and may be implemented using wire or cable, fiber optics, a phone line, a cellular phone link, an RF link or other communications channels.

As used herein the terms “computer readable medium” and “non-transitory computer readable medium” are used to generally refer to media such as memories, such as main memory 2108 and secondary memory 2110, which can be memory semiconductors (e.g., DRAMs, etc.). Computer readable medium and non-transitory computer readable medium can also refer to removable storage unit 2118, removable storage unit 2122, and a hard disk installed in hard disk drive 2112. Signals carried over communications path 2126 can also embody the logic described herein. These computer program products are means for providing software to computer system 2100.

Computer programs (also called computer control logic) are stored in main memory 2108 and/or secondary memory 2110. Computer programs may also be received via communications interface 2124. Such computer programs, when executed, enable computer system 2100 to implement the present invention as discussed herein. In particular, the computer programs, when executed, enable processor device 2104 to implement the processes of the present invention, such as the steps in the methods illustrated by the flowcharts of FIGS. 5 and 6, discussed above. Accordingly, such computer programs represent controllers of the computer system 2100. Where the invention is implemented using software, the software may be stored in a computer program product and loaded into computer system 2100 using removable storage drive 2114, interface 2120, and hard disk drive 2112, or communications interface 2124.

In an embodiment, display devices used to display interfaces of servers 116, 122, 214, 216, 320, 326, 432 of FIGS. 1-4 may be a computer display 2130 shown in FIG. 21. The computer display 2130 of computer system 2100 can be implemented as a touch sensitive display (i.e., a touch screen). For example, the computer display 2130 can be used to display the user interfaces and reports shown in FIGS. 8A, 8B, and 9-20. Also, for example, computer display 2130 can be used to display an electronic document to be signed and any attachments and supporting documentation.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.), and communication mediums (e.g., wired and wireless communications networks, local area networks, wide area networks, intranets, etc.).

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computing system from a general-purpose computing device to a specialized computing device implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied —for example, blocks can be re-ordered, combined, and/or broken into sub-blocks. Certain blocks or processes can be performed in parallel.

Conditional language used herein, such as, among others, “can,” “could,” “might,” “may,” “e.g.,” and the like, unless specifically stated otherwise, or otherwise understood within the context as used, is generally intended to convey that certain examples include, while other examples do not include, certain features, elements, and/or steps. Thus, such conditional language is not generally intended to imply that features, elements and/or steps are in any way required for one or more examples or that one or more examples necessarily include logic for deciding, with or without author input or prompting, whether these features, elements and/or steps are included or are to be performed in any particular example.

The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A computer-implemented method, comprising:
receiving, at a computing device, a request for an audience segment calculation, wherein the request indicates one or more traits of visitors of network content and a time range;
retrieving audience data based at least in part on the one or more traits and the time range; and
calculating, by the computing device, based at least in part on the retrieved audience data, audience segment sizes for a plurality of durations in the time range.

2. The method of claim 1, wherein the retrieving comprises:
translating the request into one or more queries for the audience data; and
executing the one or more queries to obtain a time series.

3. The method of claim 1, wherein the retrieving comprises retrieving audience data from a data store populated by evaluating a combined recency and frequency of one or more qualification events together according to a segment rule defining the audience segment.

4. The method of claim 1, wherein the plurality of durations include at least one duration in the past and one duration in the future.

5. The method of claim 1, wherein the plurality of durations include one or more hours, days, weeks, or portions thereof in the time range.

6. The method of claim 1, wherein the calculating comprises:
identifying patterns in the retrieved audience data;
estimating, based at least in part on the identified patterns, audience segment sizes for a plurality of past durations in the time range; and
predicting, based at least in part on the estimated audience segment sizes, at least one audience segment size for a future duration in the time range.

7. The method of claim 1, further comprising providing the calculated audience segment sizes for display, wherein the audience segment sizes each correspond to a respective one of the plurality of durations in the time range.

8. The method of claim 1, wherein the calculating comprises:
estimating at least one past audience segment size for a past duration in the time range; and
predicting at least one future audience segment size based at least in part on the estimated at least one past audience segment size, the method further comprising:
displaying, on a display of the computing device, the estimated at least one past audience segment size and the predicted at least one future audience segment size.

9. The method of claim 8, wherein the displaying comprises graphically depicting the estimated and predicted audience segment sizes for selected durations within the time range.

10. The method of claim 1, wherein the calculating comprises estimating an audience segment size in near real-time, and wherein the estimating comprises using a distributed search cluster service to search one or more qualification events within the time range.

11. The method of claim 1, wherein the calculating comprises estimating one or more audience segment sizes, wherein the estimating includes evaluating a combined recency and frequency of each of one or more qualification events that are within the time range.

12. The method of claim 11, wherein each of the one or more qualification events is associated with a time of occurrence of the respective qualification event, wherein each time of occurrence is stored with an indication of the respective qualification event.

13. The method of claim 1, wherein the calculated audience segment sizes indicate a respective number of unique visitors who qualify in respective ones of the plurality of durations in the time range, according to a segment rule.

14. A non-transitory computer readable storage medium having executable instructions stored thereon, that, if executed by a computing device, cause the computing device to perform operations comprising:
receiving a request for an audience segment calculation, wherein the request indicates one or more traits of visitors of network content and a time range;
retrieving audience data based at least in part on the one or more traits and the time range; and
calculating, based at least in part on the retrieved audience data, audience segment sizes for a plurality of durations in the time range.

15. The computer readable storage medium of claim 14, the operations further comprising:
displaying, on a display of the computing device, calculated audience segment sizes, wherein the audience segment sizes each correspond to a respective one of the plurality of durations in the time range.

16. The computer readable storage medium of claim 14, wherein the calculating comprises:
estimating at least one past audience segment size for a past duration in the time range; and
predicting at least one future audience segment size based at least in part on the estimated at least one past audience segment size.

17. A system, comprising:
a display device;
a processor; and
a memory having instructions stored thereon that, if executed by the processor, cause the processor to perform operations, the operations
comprising:
receiving a request for an audience segment calculation, wherein the request indicates one or more traits of visitors of network content and a time range;
retrieving audience data based at least in part on the one or more traits and the time range; and
calculating, based at least in part on the retrieved audience data, audience segment sizes for a plurality of durations in the time range.

18. The system of claim 17, the operations further comprising:
displaying, on the display device, calculated audience segment sizes, wherein the audience segment sizes each correspond to a respective one of the plurality of durations in the time range.

19. The system of claim 17, wherein the calculating comprises:
estimating at least one past audience segment size for a past duration in the time range; and
predicting at least one future audience segment size based at least in part on the estimated at least one past audience segment size, the operations further comprising:
displaying, on the display device, the estimated at least one past audience segment size and the predicted at least one future audience segment size.

20. The system of claim 17, wherein the retrieving comprises:
translating the request into a plurality of queries for the audience data, each of the plurality of queries corresponding to respective ones of the plurality of durations; and
executing the plurality of queries to obtain a time series.
